(19) United States
(12) Patent Application Publication
(10) Pub. No.: US 2019/0037608 A1
(43) Pub. Date: Jan. 31, 2019

(54) USER TERMINAL, RADIO BASE STATION, AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 16/074,475

(22) PCT Filed: Feb. 2, 2017
(86) PCT No.: PCT/JP2017/003706

§ 371 Date: Aug. 1, 2018

(30) Foreign Application Priority Data
Feb. 4, 2016 (JP) 2016-020014

(51) Int. Cl. H04W 74/08

(52) U.S. Cl. CPC H04W 74/0833; H04W 74/0808

(57) ABSTRACT

To achieve an appropriate random access operation even when multiple carriers to which Listen Before Talk (LBT) is applied belong to one timing advance group (TAG), a user terminal according to an aspect of the present invention includes a control unit for controlling a random access procedure on two or more carriers on which listening is performed before uplink transmission, a transmission unit for transmitting a random access preamble on at least one of the two or more carriers, and a reception unit for receiving a response signal in response to the random access preamble. The control unit controls the transmission unit to stop transmission of the random access preamble on the two or more carriers in accordance with reception of the response signal.

### TECHNICAL FIELD

The present invention relates to a user terminal, a radio base station, and a radio communication method in next-generation mobile communication systems.

### BACKGROUND ART

In Universal Mobile Telecommunications System (UMTS) networks, Long Term Evolution (LTE) has been specified for the purpose of providing increased data rates, reduced delay, and the like (non-patent document 1). To achieve further broadbandization and increased speed beyond LTE (LTE Release 8 or 9), LTE-Advanced (LTE-A, also referred to as LTE Release 10, 11, or 12) has been specified, and successor systems to LTE (Future Radio Access (FRA), 5th generation mobile communication system (5G), LTE Release 13 or later) are studied.

LTE Releases 8 to 12 have been specified on the assumption that communication is exclusively performed in frequency bands (licensed bands) that communication common carriers (operators) are licensed to use. As the licensed bands, for example, 800 MHz, 1.7 GHz, 2 GHz, and the like are available.

The widespread use of sophisticated user terminals (user equipment (UE)) such as smartphones and tablets has caused a sudden increase in user traffic. To accommodate the increased user traffic, the addition of more frequency bands is required, but there is a limit to the spectrum of licensed bands (licensed spectrum).

Thus, LTE Release 13 studies an extension of frequencies in LTE systems using bands of a usable unlicensed spectrum (unlicensed bands) other than the licensed bands (non-patent document 2). As the unlicensed bands, for example, the use of a 2.4 GHz band, a 5 GHz band, and the like in which Wi-Fi (trademark) and Bluetooth (trademark) are available is studied.

To be more specific, LTE Release 13 studies Carrier Aggregation (CA) of the licensed bands and the unlicensed bands. Communication using the unlicensed bands together with the licensed bands is referred to as Licensed-Assisted Access (LAA). Note that, LAA may possibly include Dual Connectivity (DC) of the licensed bands and the unlicensed bands, and Stand-Alone (SA) of the unlicensed bands in the future.

In the unlicensed bands in LAA, the introduction of an interference control function is considered in order to coexist with LTE, Wi-Fi, and other systems of other communication common carriers. Wi-Fi uses Listen Before Talk (LBT) based on Clear Channel Assessment (CCA), as the interference control function in the same frequency band. LBT is a technique in which listening (sensing) is performed before transmitting a signal to control the transmission based on the listening result. For example, in Japan, Europe, and other countries, the LBT function is specified to be indispensable to Wi-Fi and other systems using the 5 GHz unlicensed band.

### CITATION LIST

### Non Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall description; Stage 2”

Non-Patent Literature 2: AT&T “Drivers, Benefits and Challenges for LTE in Unlicensed Spectrum,” 3GPP TSG RAN Meeting #62 RP-131701

### SUMMARY OF INVENTION

### Technical Problem

LTE systems perform timing control on the basis of each timing advance group (TAG) in uplink Carrier Aggregation (UL-CA) using Multiple Timing Advance (MTA). Information for adjusting uplink transmission timing using non-contention-based random access is calculated for each TAG.

However, when multiple carriers to which LBT is applied belong to one TAG, the use of a conventional random access procedure may reduce frequency use efficiency.

Considering the above, one of the objects of the present invention is to provide a user terminal, a radio base station, and a radio communication method that can achieve an appropriate random access operation, even when multiple carriers to which LBT is applied belong to one TAG.

### Solution to Problem

A user terminal according an aspect of the present invention includes a control unit for controlling a random access procedure on two or more carriers on which listening is performed before uplink transmission, a transmission unit for transmitting a random access preamble on at least one of the two or more carriers, and a reception unit for receiving a response signal in response to the random access preamble. The control unit controls the transmission unit to stop transmission of the random access preamble on the two or more carriers in accordance with reception of the response signal.

### Advantageous Effects of Invention

According to the present invention, even when multiple carriers to which LBT is applied belong to one TAG, it is possible to achieve an appropriate random access operation.

### BRIEF DESCRIPTION OF DRAWINGS

FIG. 1 is a drawing depicting an example of a sequence of a random access procedure on an SCell in existing LTE systems;

FIG. 2 is a drawing depicting the structure of a MAC PDU for a RAR in the existing LTE systems;

FIGS. 3A to 3C are drawings depicting examples of envisioned scenarios, when CA is applied to licensed CCs and unlicensed CCs;

FIGS. 4A and 4B are drawings depicting an example of a problem when one TAG includes multiple unlicensed CCs;

FIGS. 5A and 5B are drawings depicting another example of the problem when the TAG includes the multiple unlicensed CCs;

FIG. 6 is a schematic explanatory view of a first embodiment;

FIG. 7 is a drawing depicting an example of an RA procedure according to the first embodiment;

FIG. 8 is a drawing depicting another example of the RA procedure according to the first embodiment;

FIG. 9 is a drawing depicting an example of the RA procedure according to a modification example of the first embodiment;

FIG. 10 is a drawing depicting another example of the RA procedure according to the modification example of the first embodiment;

FIG. 11 is a schematic explanatory view of a second embodiment;

FIG. 12 is a drawing depicting an example of an RA procedure according to the second embodiment;

FIG. 13 is a drawing depicting an example of the schematic configuration of a radio communication system according to an embodiment of the present invention;

FIG. 14 is a drawing depicting an example of the entire configuration of a radio base station according to the embodiment of the present invention;

FIG. 15 is a drawing depicting an example of the functional configuration of the radio base station according to the embodiment of the present invention;

FIG. 16 is a drawing depicting an example of the entire configuration of a user terminal according to the embodiment of the present invention;

FIG. 17 is a drawing depicting an example of the functional configuration of the user terminal according to the embodiment of the present invention; and

FIG. 18 is a drawing depicting an example of the hardware configuration of each of the radio base station and the user terminal according to the embodiment of the present invention.

### DESCRIPTION OF EMBODIMENTS

LTE or LTE-A systems using unlicensed bands (e.g., LAA systems) are assumed to require an interference control function in order to coexist with LTE, Wi-Fi, and other systems of other communication common carriers. Note that, the LTE or LTE-A systems using the unlicensed bands may be collectively referred to as LAA, LAA-LTE, LTE-U, U-LTE, and the like irrespective of whether the systems use CA, DC, or SA.

In general, when transmission points (e.g., radio base stations (eNBs), user terminals (UEs), and the like) that perform communication using carriers (may be also referred to as carrier frequencies or simply frequencies) in unlicensed bands detect another entity (e.g., another UE) that is performing communication on a carrier in an unlicensed band, the transmission points are inhibited from performing transmission on the carrier.

Thus, each transmission point performs listening for a certain time period before transmission timing (LBT). To be more specific, each transmission point that performs LBT searches an entire carrier band (e.g., one component carrier (CC)) a certain time period before transmission timing (e.g., in immediately preceding subframe) to check whether or not another device (e.g., another radio base station, UE, Wi-Fi device, or the like) is performing communication on the carrier band.

In this application, the listening refers to an operation in which the transmission point (e.g., radio base station, user terminal, or the like) detects or measures whether or not a signal of a certain level (e.g., certain power) or more is transmitted from another transmission point or the like, before performing transmission of a signal. The listening performed by radio base stations and/or user terminals may be referred to as LBT, CCA, carrier sense, or the like.

LBT performed by, for example, eNBs before downlink transmission may be referred to as DL LBT, while LBT performed by, for example, UEs before uplink transmission may be referred to as UL LBT. The UE may be notified of information about a carrier to which UL LBT is to be applied, and may perform UL LBT on the carrier determined based on the information.

When the transmission point has verified that no other device is communicating, the transmission point performs communication using the carrier. For example, when a reception power level measured by LBT (reception signal power level during LBT) is an established threshold value or less, the transmission point determines that the channel is in an idle state (LBT_{idle}) and performs transmission thereon. “The channel is in an idle state” means that the channel is not occupied by a specific system, and is also represented as “the channel is idle”, “the channel is clear”, “the channel is free”, or the like.

On the other hand, when the transmission point has detected that another device is using the carrier band, or even just a part thereof, the transmission point stops transmission processing itself. For example, when the transmission point has detected that the reception power level of a signal from another device on the carrier band is more than the established threshold value, the transmission point determines that the channel is in a busy state (LBT_{busy}) and does not perform transmission. In the LBT_{busy}, the channel becomes available only after the channel has been verified to be in the idle state by applying LBT again. The determination method of the channel between the idle state and the busy state by LBT is not limited thereto.

As mechanisms (schemes) for LBT, Frame Based Equipment (FBE) and Load Based Equipment (LBE) are studied. The differences therebetween are a frame structure, a channel occupancy time, and the like. In FBE, a transmission and reception structure related to LBT has specific timing. In LBE, a transmission and reception structure is not specific in a time axial direction, and LBT is applied on demand.

To be more specific, FBE is a mechanism in which a frame period is specific, and carrier sense is performed in a certain frame for a certain duration (LBT duration). As a result of the carrier sense, when a channel is available, transmission is performed. When the channel is unavailable, transmission stands still until carrier sense is performed in the next frame.

LBE is a mechanism in which when a channel is unavailable as a result of performing carrier sense (initial CCA), an extended CCA (ECCA) procedure is performed. In other words, a carrier sense time is elongated to continuously perform carrier sense until the channel becomes available. LBE requires random backoff for the purpose of appropriate collision avoidance.

The carrier sense time (a carrier sense period) is a time (e.g., one symbol length) for determining the availability of a channel by performing listening or the like, to obtain one LBT result.

The transmission point can transmit a certain signal (e.g., a channel reservation signal) depending on a LBT result. Here, the LBT result refers to information (e.g., LBT_{idle} and LBT_{busy}) related to the availability of a channel in a carrier to which LBT is applied, obtained by LBT.

When LBT results in an idle state (LBT_{idle}), the transmission point can start transmission while not performing LBT for a certain period of time (e.g., 10 to 13 ms). This transmission is also referred to as burst transmission, a burst, or a transmission burst.

As described above, in the LAA systems, introducing interference control based on the LBT mechanism in a single frequency into the transmission points allows for preventing interference between the LAA system and Wi-Fi, interference between the LAA systems, and the like. Even when each operator of the LAA system independently controls the transmission points, LBT serves to reduce interference without grasping the contents of the control by each operator.

Even cells of unlicensed bands are sometimes required to perform a random access (RA) procedure, in order to adjust uplink transmission timing. For example, when the distance between a UE and an eNB that forms an SCell (secondary cell) of an unlicensed band is different from the distance between the UE and another eNB that forms a PCell (primary cell) of a licensed band, the transmission timing of the SCell is likely different from the transmission timing of the PCell. Note that, the SCell of the unlicensed band may be referred to as, for example, an LAA SCell.

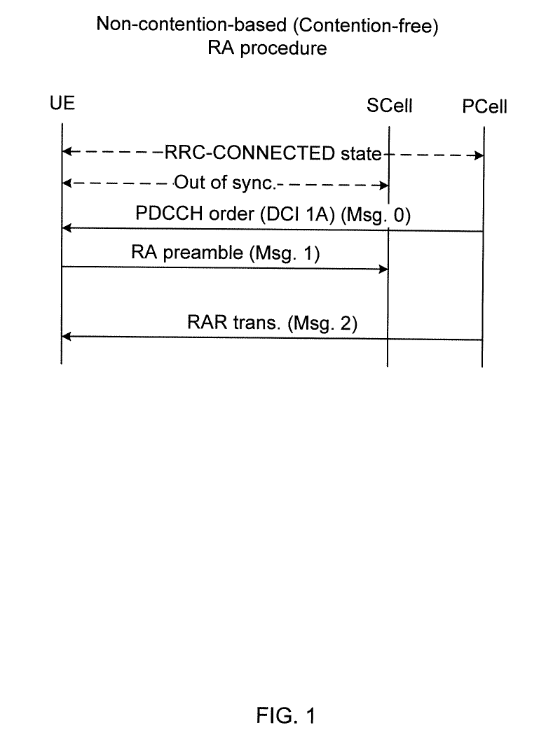

First, an example of an RA procedure of an SCell of a licensed band using a PCell of a licensed band will be described with reference to FIG. 1. FIG. 1 is a drawing depicting an example of a sequence of an RA procedure on an SCell in existing LTE systems. In an initial state of the sequence of FIG. 1, a UE is in an asynchronous state with the SCell, while maintaining RRC connection with a PCell. This describes a case where the PCell and the SCell perform CA as an example, but DC may be performed instead.

In FIG. 1, the SCell performs control based on non-contention-based random access (Non-CBRA). In the example of FIG. 1, a network side (e.g., eNB) transmits a transmission order of a physical random access channel (PRACH) of the SCell to the UE on a downlink L1/L2 control channel (e.g., a physical downlink control channel (PDCCH) or an enhanced PDCCH (EPDCCH)) of the PCell (message (Msg.) 0).

Message 0 contains information related to PRACH transmission such as a preamble index related to a UE-specific RA preamble, and is used by the UE to initialize the RA procedure. Message 0 has, for example, a downlink control information (DCI) format 1A. Message 0 may be referred to as a PDCCH order, a PRACH trigger, a signal to start non-contention-based RA, random access start information, random access command information, random access allocation information (random access preamble assignment), or the like.

Next, the UE transmits an RA preamble (PRACH) based on the received DCI on the SCell (message 1). Upon detecting the RA preamble transmitted from the UE by the SCell, the network side transmits a random access response (RAR) on the PCell (message 2).

Note that, an identifier of the RA preamble (random access radio network temporary identifier (RA-RNTI)) is determined based on the following equation (1).

RA−RNTI=1+t_{id}+10×f_{id} Equation 1:

wherein, t_{id} is a subframe number (e.g., 0 to 9) in which the RA preamble is transmitted, and f_{id} is a frequency resource number (e.g., 0 to 5).

When the transmission of the PRACH is completed, the UE attempts to receive DCI for the RAR (DCI used to specify a resource to receive the RAR) in response to the PRACH for a certain period of time. The period (RAR reception attempt period) to attempt to receive the DCI for the RAR may be referred to as an RAR window. When the reception of a PDCCH for the RAR does not succeed in the RAR window, the UE may transmit the PRACH again.

The PRACH is retransmitted with an increased transmission power (by power ramping). The transmission power of the PRACH is controlled by a MAC layer, and more specifically, controlled based on the number of transmissions of the preamble (PREAMBLE_TRANSMISSION_COUNTER). The preamble transmission number is incremented whenever retransmission is performed.

The RAR window is established for a certain period from a certain subframe after the transmission of the RA preamble (PRACH transmission). For example, the RAR window starts from a subframe that is three or more subframes later than the completion of the transmission of the RA preamble, and has a length (RAR window size) of a certain number of subframes. The eNB may notify the UE of the RAR window size (ra-ResponseWindowSize) by higher layer signaling (e.g., radio resource control (RRC) signaling) or the like.

The RAR transmission includes transmission of the DCI for the RAR on the PDCCH and transmission of a medium access control protocol data unit (MAC PDU) indicating the RAR on a PDSCH. The DCI for the RAR is transmitted on a common search space (CSS).

Thus, even when the PRACH is transmitted on the SCell, a cell (e.g., PCell) in which CSS is established has to perform a reception operation. As described above, when the PRACH is transmitted on the different cell from the cell on which the response signal (RAR) of the PRACH is received, the UE controls the reception (reception timing, decoding processing, and the like) of the RAR based on subframe information (e.g., subframe number) and the like of the cell on which the PRACH is transmitted. The RAR may be received on a cell other than the PCell.

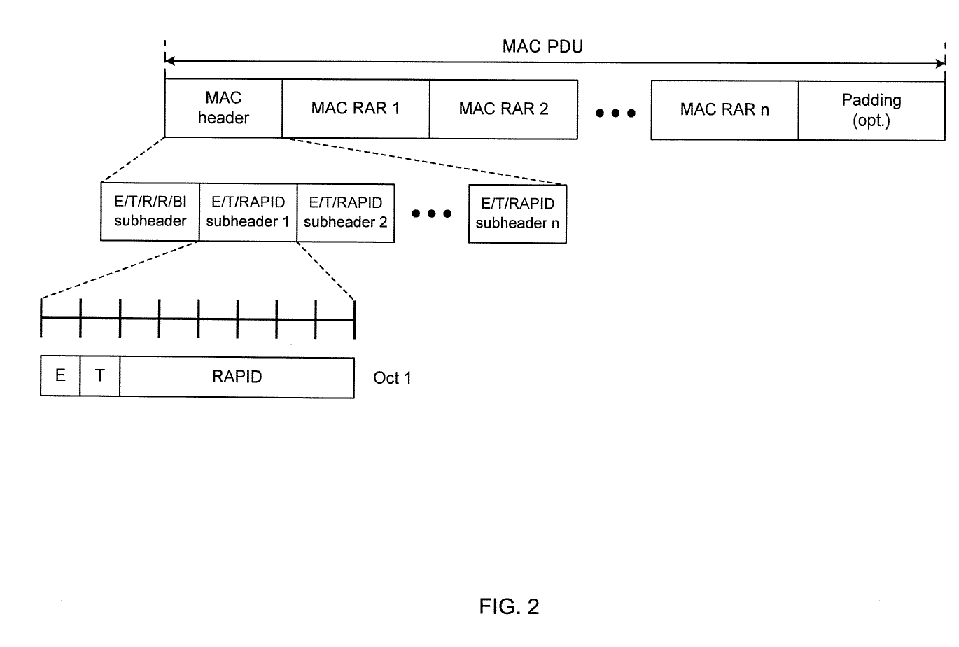

FIG. 2 is a drawing depicting the structure of the MAC PDU for the RAR in the existing LTE systems. As depicted in FIG. 2, the conventional MAC PDU for the RAR (in the LTE systems of Releases 12 or earlier) includes a MAC header, which contains one or more MAC subheaders indicating identifiers (e.g., random access preamble identifiers (RAPIDs) corresponding to identifiers of RA preambles (random access radio network temporary identifiers (RA-RNTIs)), and MAC RARs corresponding to the RAPIDs. The RAPID of 6 bits is an identifier contained in the MAC subheader.

Note that, the conventional MAC RAR (in the LTE systems of Releases 12 or earlier) has 6 octets (=48 bits). To be more specific, the MAC RAR is constituted of a 1-bit reserved (R) field, an 11-bit timing advance command (TAC) field, a 20-bit uplink (UL) grant field, and a 16-bit temporary cell radio network temporary identifier (TC-RNTI) field.

The reserved field may not be specifically used for information notification, and may be used freely. The TAC field contains information (uplink transmission timing information) for adjusting uplink transmission timing. The TC-RNTI field contains temporary information (temporary terminal identifier) for identifying a terminal.

The UE adjusts uplink transmission timing using a TAC contained in the received RAR. Therefore, non-contention-based RA processing is completed, and connection with the SCell is established.

The UE can perform uplink transmission after the reception of the RAR based on a UL grant contained in the RAR. For example, the UE can transmit aperiodic channel state information (CSI), a certain MAC control element (CE), data, and the like. As the MAC CE, a power headroom report (PHR) MAC CE, a buffer status report (BSR) MAC CE, and the like may be transmitted.

In LTE systems, during multiple timing advance (MTA) uplink Carrier Aggregation (UL-CA), timing control is performed on the basis of a timing advance group (TAG). Since each TAG does not necessarily include a PCell, non-contention-based RA is introduced to a SCell.

In conventional LTE, an eNB triggers PRACH transmission on only one CC within a single TAG (does not trigger PRACH transmission on multiple CCs within a single TAG). This is because the conventional LTE is premised on licensed CCs, and the UE can perform the PRACH transmission without delay in response to the trigger for the PRACH transmission.

However, in the case of unlicensed CCs, since LBT is required before PRACH transmission, triggering PRACH transmission on only one unlicensed CC may be insufficient for the transmission.

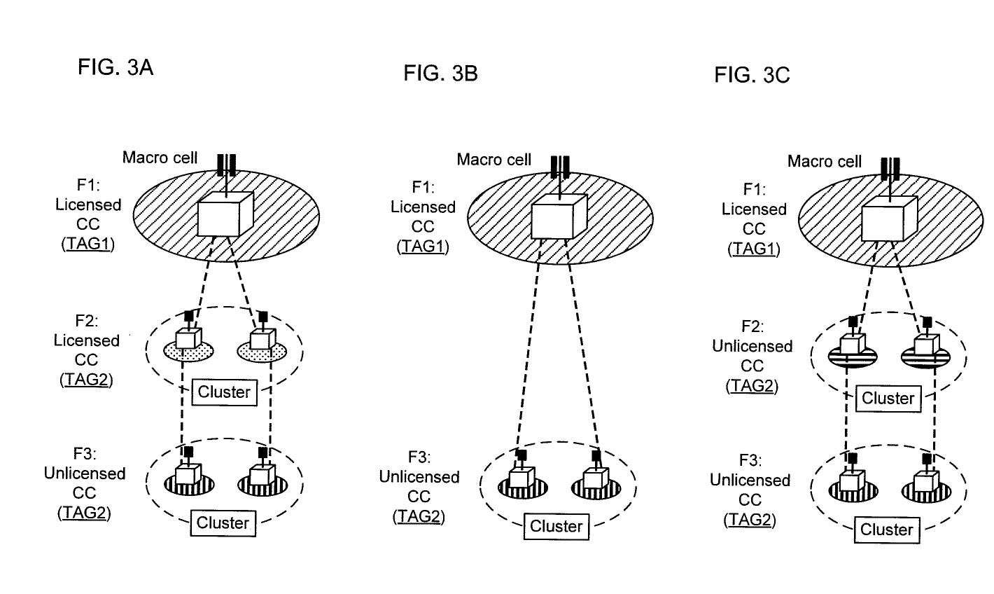

FIGS. 3A to 3C are drawings depicting examples of envisioned scenarios, when CA is applied to licensed CCs and unlicensed CCs. In FIGS. 3A to 3C, two TAGs are established. In any example, a TAG1 corresponds to a licensed CC (frequency F1). On the other hand, a TAG2 includes a licensed CC (frequency F2) and an unlicensed CC (frequency F3) in FIG. 3A, includes one unlicensed CC (F3) in FIG. 3B, and includes two unlicensed CCs (F2 and F3) in FIG. 3C.

In the scenario of FIG. 3A, the uplink transmission timing of the TAG2 including the unlicensed CC (F3) coincides with the uplink transmission timing of the licensed CC (F2) belonging to the same TAG. Thus, performing the RA procedure on the F2 prevents the occurrence of an event in which PRACH transmission cannot be performed.

In the scenario of FIG. 3B, the uplink transmission timing of the TAG2 including only the unlicensed CC (F3) is adjusted by performing the RA procedure on the F3. In this case, upon triggering PRACH transmission on the F3, the UE performs LBT before the PRACH transmission. When LBT results in LBT_{idle}, the UE transmits a PRACH and attempts to receive a RAR.

On the other hand, when LBT results in LBT_{busy}, the UE cannot transmit the PRACH. In this case, applying conventional power ramping to the PRACH may possibly increase a PRACH transmission power to an excessive level after LBT_{busy} has continued.

Against this problem, the use of a similar method to a PRACH transmission power control method in a power limited state in DC of Release 12 is considered. To be more specific, when LBT results in LBT_{busy}, a PHY layer transmits information (power ramping suspension indicator) related to suspension of power ramping to a MAC layer.

Upon receiving the information, the MAC layer avoids incrementing the preamble transmission number (PREAMBLE_TRANSMISSION_COUNTER). In other words, the next transmission is performed using a transmission power that is intended to be used in this PRACH transmission. This prevents inappropriate power ramping.

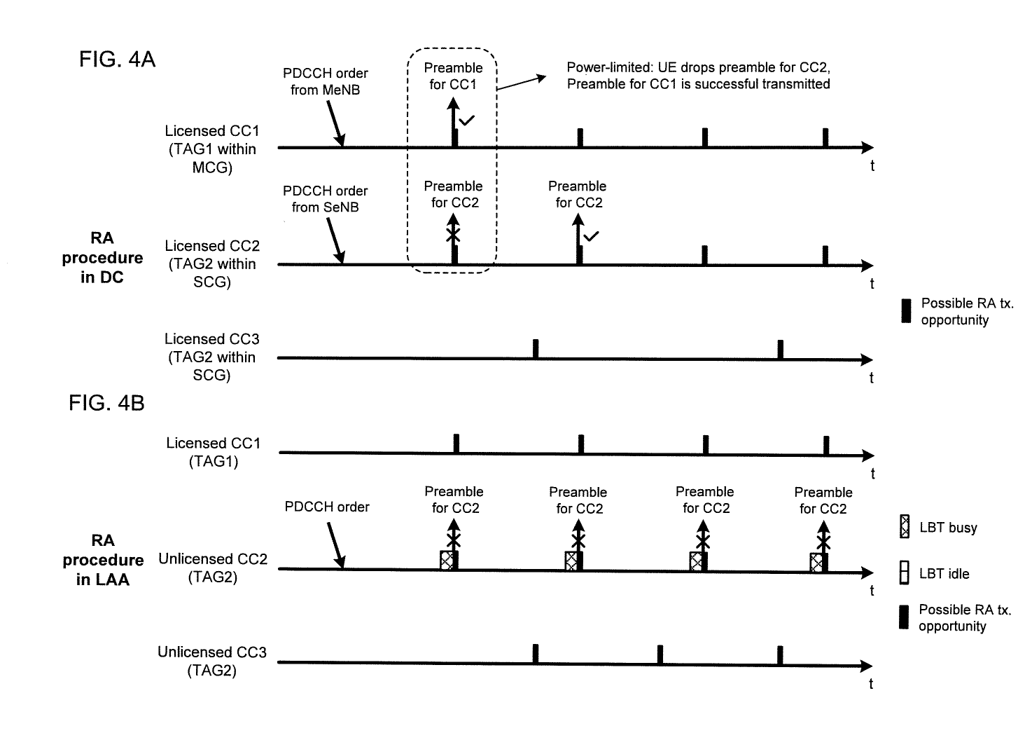

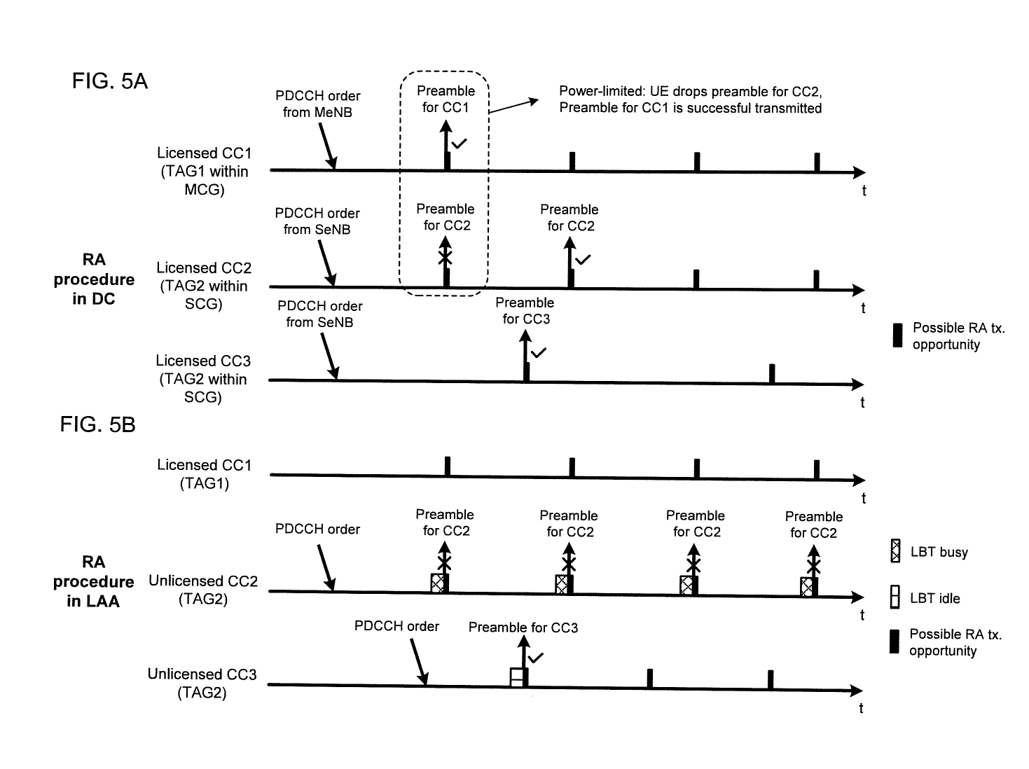

In the scenario of FIG. 3C, the uplink transmission timing of the TAG2, which includes only the unlicensed CCs (F2 and F3) independently of the TAG1 including the licensed CC, is adjusted by performing the RA procedure on the F2 and/or F3. The inventors have focused attention on the fact that applying the conventional RA procedure based on the PRACH trigger to the scenario of FIG. 3C causes problems in the adjustment of the uplink transmission timing. The problems will be described below in detail with reference to FIGS. 4A to 5B.

FIGS. 4A to 5B are drawings depicting examples of the problems when one TAG includes multiple unlicensed CCs. FIGS. 4A and 5A depict a case in which an MCG including a CC1 belonging to a TAG1 and an SCG including two CCs (CC2 and CC3) belonging to a TAG2 perform DC, as a comparative example. FIGS. 4B and 5B depict a case in which a licensed CC (CC1) belonging to a TAG1 and two unlicensed CCs (CC2 and CC3) belonging to a TAG2 perform CA.

FIGS. 4A to 5B depict PRACH transmittable timings (possible RA tx. opportunities), which are common to the CC1 and CC2, but are different for the CC3 from the other CCs. This is for the sake of easy description, and the PRACH transmittable timings of each CC are not limited thereto. In FIGS. 4A and 5A, a PRACH trigger for the CC1 is transmitted in the same timing as a PRACH trigger for the CC2.

In FIGS. 4A and 4B, assuming that the RA procedure for the TAG2 is performed on the CC2, a UE is informed of a PRACH trigger related to the CC2. In FIG. 4A, since PRACH transmission is performed in the same timing on the CC1 and the CC2, the UE enters a state (power limited state) exceeding an allowable transmission power of the UE. However, since the MCG has higher priority in the PRACH concurrent transmission, the PRACH transmission is first performed on the CC1. After that, the PRACH transmission (retransmission) is performed on the CC2.

In FIG. 4B, since the channel of CC2 is occupied, an LBT result on the CC2 continuously indicates LBT_{busy}, thus failing to perform PRACH transmission. In this manner, when a PRACH trigger is transmitted to only one unlicensed CC, even if another unlicensed CC belonging to the same TAG is free, the unlicensed CC has no opportunity to perform PRACH transmission.

In FIGS. 5A and 5B, assuming that the RA procedure for the TAG2 is performed on the CC2 and the CC3, a UE is informed of a PRACH trigger related to the CC2 and a PRACH trigger related to the CC3. In FIG. 5A, just as in FIG. 4A, the UE enters a power limited state on the CC1 and the CC2, and PRACH transmission is first performed on the CC1. After that, PRACH transmission is performed on the CC3. After that, PRACH transmission (retransmission) is performed on the CC2.

In FIG. 5B, PRACH transmission is performed on the CC3, because LBT_{idle} is obtained in the first LBT on the CC3. However, since the channel of CC2 is occupied, an LBT result on the CC2 continuously indicates LBT_{busy}, thus failing to perform PRACH transmission. In this manner, when PRACH triggers are transmitted to multiple unlicensed CCs, the RA procedure is performed independently on each CC.

Thus, even when a timing advance (TA) has been obtained on one CC (e.g., CC3 of FIG. 5B), the RA procedure is continued on another CC (e.g., CC2 of FIG. 5B).

As described above, when multiple carriers to which LBT is applied belong to one TAG, obtainment of TA using the conventional RA procedure may reduce frequency use efficiency, owing to less opportunity for PRACH transmission due to LBT and performing the useless RA procedure.

Therefore, the inventors have devised the idea of, when multiple carriers to which LBT is applied belong to one TAG, establishing one or more RA procedures on the carriers and stopping an unnecessary RA procedure quickly after a TA has been obtained. According to an aspect of the present invention, in a TAG that includes only carriers to which UL LBT is applied, it is possible to increase opportunities for PRACH transmission, and prevent an increase in communication delay and a reduction in frequency use efficiency.

Embodiments of the present invention will be described below in detail with reference to the attached drawings. In each embodiment, CA is applied to a primary cell (PCell) in a licensed band and an SCell in unlicensed bands, but the invention is not limited thereto.

In other words, in each embodiment, a licensed band (and PCell) may constitute a carrier to which no listening (LBT) is applied (a carrier on which no LBT is performed, a carrier on which no LBT can be performed, or the like), while an unlicensed band (and SCell) may constitute a carrier to which listening (LBT) is applied (a carrier on which LBT is performed, a carrier on which LBT is intended to be performed).

The combination between the carriers to which LBT is applied or not applied and the combination between the PCell and the SCell are not limited to the above. For example, the present invention is applicable to a case where, for example, a UE is connected to unlicensed bands on a standalone basis (both of a PCell and a SCell are carriers to which LBT is applied).

### Radio Communication Method

### First Embodiment

In a first embodiment of the present invention, when multiple CCs (e.g., unlicensed CCs) to which LBT is applied belong to one TAG, a UE receives PRACH triggers related to at least two or more CCs belonging to the TAG, and starts RA procedures independently on each CC. When the UE has succeeded in receiving a RAR in any of the two or more RA procedures, the UE stops the remaining RA procedures (for example, stop the transmission or retransmission of RA preambles).

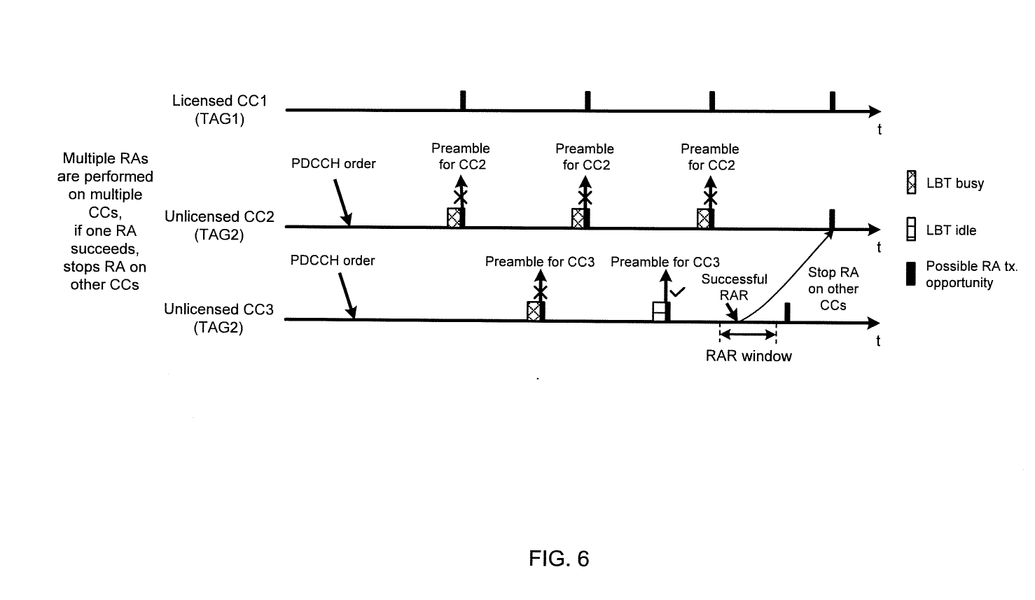

FIG. 6 is a schematic explanatory view of the first embodiment. FIG. 6 depicts the same example as FIG. 5B. In the example of FIG. 6, when a UE has succeeded in PRACH transmission on a CC3 and then has succeeded in receiving a RAR during a RAR window, the UE avoids PRACH transmission on a CC2 belonging to the same TAG.

To be more specific, an example of the first embodiment is embodied by the following steps ST11 to ST14. First, eNBs transmit a plurality of (separate) PDCCH orders on multiple unlicensed CCs belonging to the same TAG so as to independently trigger PRACH transmission (step ST11).

The UE performs LBT on the multiple unlicensed CCs ordered in step ST11. When LBT_{idle} is obtained on any of the unlicensed CCs, PRACH transmission is performed thereon (step ST12). However, step ST12 is performed only until the UE succeeds in receiving a RAR including a RAPID corresponding to a transmitted RA preamble.

The eNBs receive RA preambles of the triggered CCs, and transmit RARs related to one or more successfully received PRACHs on a PCell (step ST13). The eNBs may transmit RARs corresponding to all of the successfully received PRACHs, or choose one or more of the received PRACHs and transmit RARs corresponding to the chosen PRACHs. At this time, the UE attempts to receive the RAR including a RAPID corresponding to the transmitted RA preamble in a RAR window of each CC.

When the UE has succeeded in receiving the RAR related to at least one of the CCs, the UE stops the PRACH transmission on every CC belonging to the same TAG (step ST14). When a RAR window does not elapse (a RAR reception attempt is carried on) on any CC, the UE stops the RAR reception attempt.

When the UE has succeeded in receiving the RAR related to one CC in step ST13, the UE can apply a TA value included in the RAR to the TAG to which the CC belongs. When the UE has succeeded in receiving a plurality of RARs, the UE may choose an arbitrary CC and use a TA value included in the RAR received on the CC, or may use a TA value included in the RAR received on any CC determined in accordance with a specific rule (for example, a CC having a minimum CC index, a CC having a maximum CC index, and the like of CCs on which the RARs are received) (step ST15).

In the UE, a RAR window size, parameters related to transmission and/or retransmission power of a preamble (e.g., initial transmission power of the preamble (preambleInitialReceivedTargetPower), an offset based on a preamble format (DELTA_PREAMBLE), and an increase in power for power ramping (powerRampingStep)), and the like may be set by higher layer signaling on a CC-by-CC basis. At least one of the parameters may be set at a common value to multiple CCs. The UE manages the preamble transmission number (PREAMBLE_TRANSMISSION_COUNTER) on a CC-by-CC basis.

In existing LTE systems, preamble transmission power (Preamble Tx power) calculated in a MAC layer is represented by the following equation (2).

Preamble Tx power=preambleInitialReceivedTargetPower+DELTA_PREAMBLE+(PREAMBLE_TRANSMISSION_COUNTER−1)*powerRampingStep Equation (2):

In the first embodiment, the preamble transmission power may be controlled on a CC-by-CC basis based on equation (2) or another equation.

In the first embodiment, after a PRACH is transmitted to a certain CC, the preamble transmission number of the CC is incremented by 1, when no RAR is received in a RAR window of the CC or any received RAR does not include an identifier (RAPID) corresponding to the transmitted RA preamble, and when a PHY layer does not notify a MAC layer of information related to a stop of power ramping on the CC (when a LBT result indicates LBT_{idle}).

The UE may determine multiple RA resources (periodic resources designated by a PRACH configuration index, may be referred to as PRACH resources) to be usable, or determine one RA resource (aperiodic one RA resource) of the unlicensed CCs to be usable based on one PDCCH order. In the latter case, the applications of subframes are not limited after the transmission of the PDCCH order.

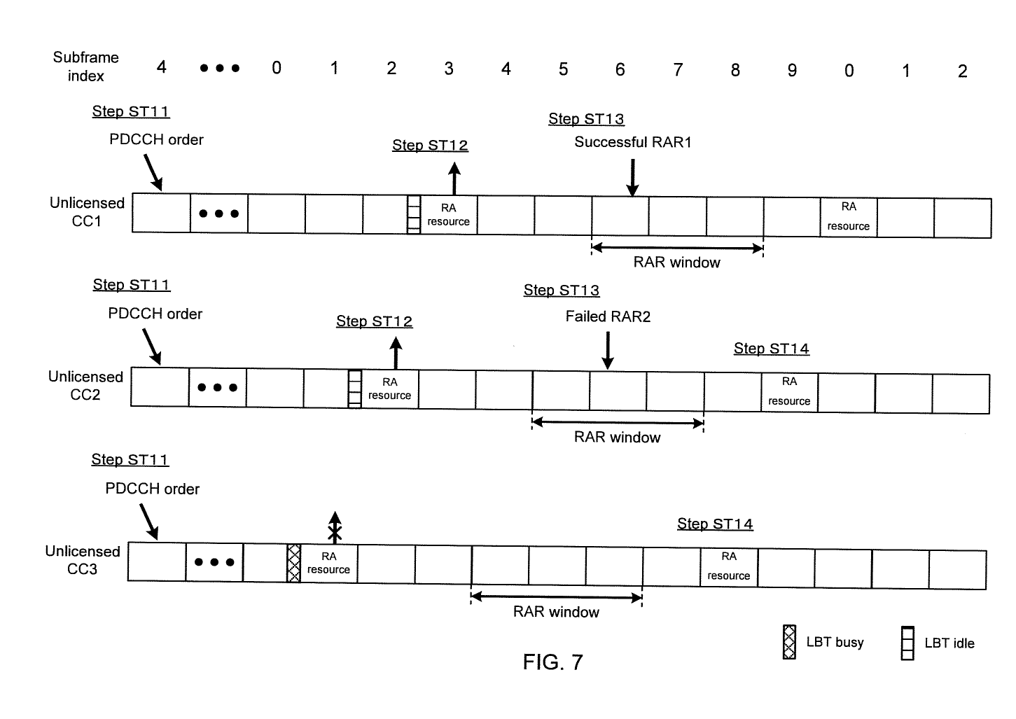

A concrete example of the first embodiment will be described below. FIG. 7 is a drawing depicting an example of an RA procedure according to the first embodiment. In this example, CA of three unlicensed band CCs (CC1 to CC3) is applied to a UE. In each CC, a RAR window is set at 3.

In FIG. 7, the UE receives separate PDCCH orders in a certain subframe on the CC1 to CC3 so as to independently trigger RA procedures (PRACH transmission). In this example, the UE grasps that each PDCCH order makes an RA resource of each CC available with a period of 7 subframes, and continuous subframes are allocated in order of CC3, CC2, and CC1.

Next, the UE performs processing of step ST12. First, the UE performs LBT on the CC3 in subframe #0, in order to perform PRACH transmission on the CC3 in subframe #1. In this embodiment, LBT results in LBT_{busy}, and the PRACH transmission cannot be performed on the CC3. In this case, as described above, a PHY layer of the UE notifies a MAC layer of information related to a stop of power ramping, so as not to increment the number (T_{CC3}) of transmissions of a preamble on the CC3.

Since LBT performed on the CC2 in subframe #1 results in LBT_{idle}, the UE performs PRACH transmission on the CC2 in subframe #2. Since LBT performed on the CC1 in subframe #2 results in LBT_{idle}, the UE performs PRACH transmission on the CC1 in subframe #3.

In step ST13, the UE fails to receive a RAR (failed RAR2) on the CC2, while succeeds in receiving a RAR (successful RAR1) on the CC1. The UE can perform the above-described power ramping processing on the CC on which the UE has failed the RAR reception. In this example, the UE may increment the number (T_{CC2}) of transmissions of a preamble on the CC2 by 1 and ramp the power of the next PRACH retransmission on the CC2 by a powerRampingStep.

Since the UE has succeeded in receiving the RAR on the CC1, the UE stops PRACH transmission on the CC2 and the CC3 that belong to the same TAG as the CC1 (step ST14). The UE can thereby obtain a TA.

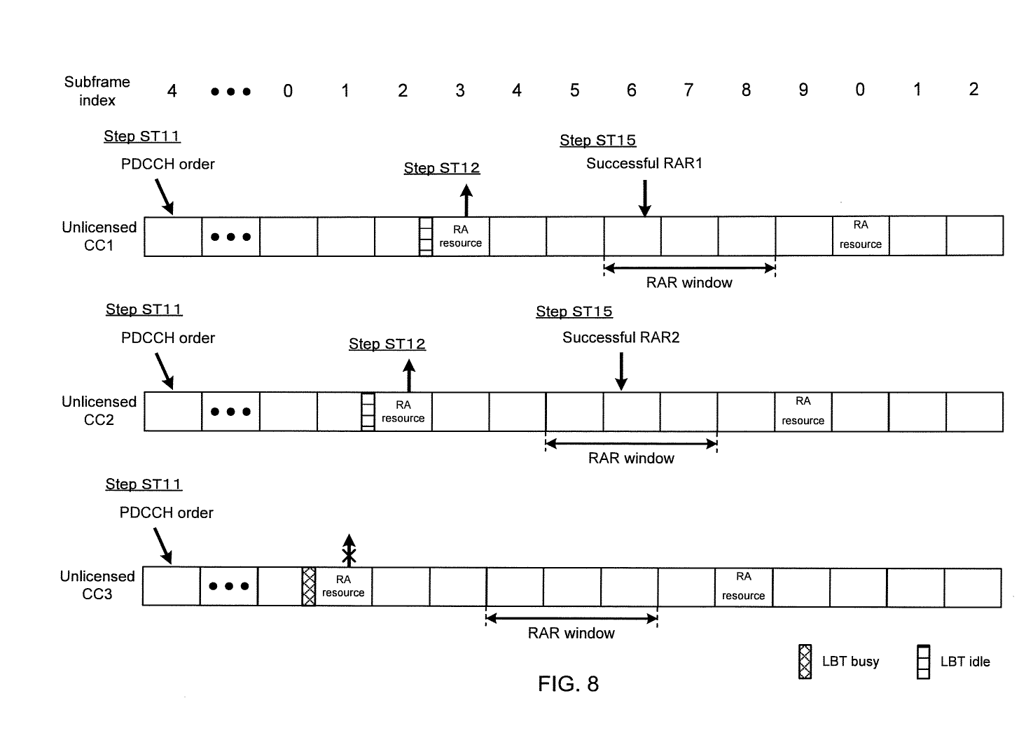

FIG. 8 is a drawing depicting another example of the RA procedure according to the first embodiment. This example describes processing (step ST15) when the UE succeeds in receiving a plurality of RARs in step ST13 of the example of FIG. 7.

The UE may use a TA value of any one of the RAR1 and the RAR2, which are successfully received in step ST15, for the TAG constituted of the CC1 to CC3. The UE may use a TA value of any one of the RAR1 and the RAR2 in accordance with a specific rule. For example, the UE may use a RAR received on the CC1, which has a smaller CC index than the CC2.

According to the first embodiment as described above, since the multiple unlicensed CCs start the independent RA procedures, it is possible to reduce the effects of a reduction in opportunities of PRACH transmission due to LBT. Since each RA procedure is stopped after the TA has been obtained, it is possible to prevent an increase in a load of the UE.

### Modification Example of First Embodiment

Even when the UE has succeeded in PRACH transmission on the multiple CCs and the eNBs have received the plurality of PRACHs, as depicted in FIGS. 7 and 8, the eNBs do not have to transmit RARs in response to all of the PRACHs. The eNBs may choose an arbitrary CC from the one or more CCs on which the PRACHs have been successfully received, and control the transmission of a RAR on the chosen CC (option 1). The eNBs may control the transmission of a RAR on any of the CCs determined in accordance with a specific rule (for example, a CC having a minimum CC index, a CC having a maximum CC index, and the like out of the CCs on which the PRACHs are received) (option 2).

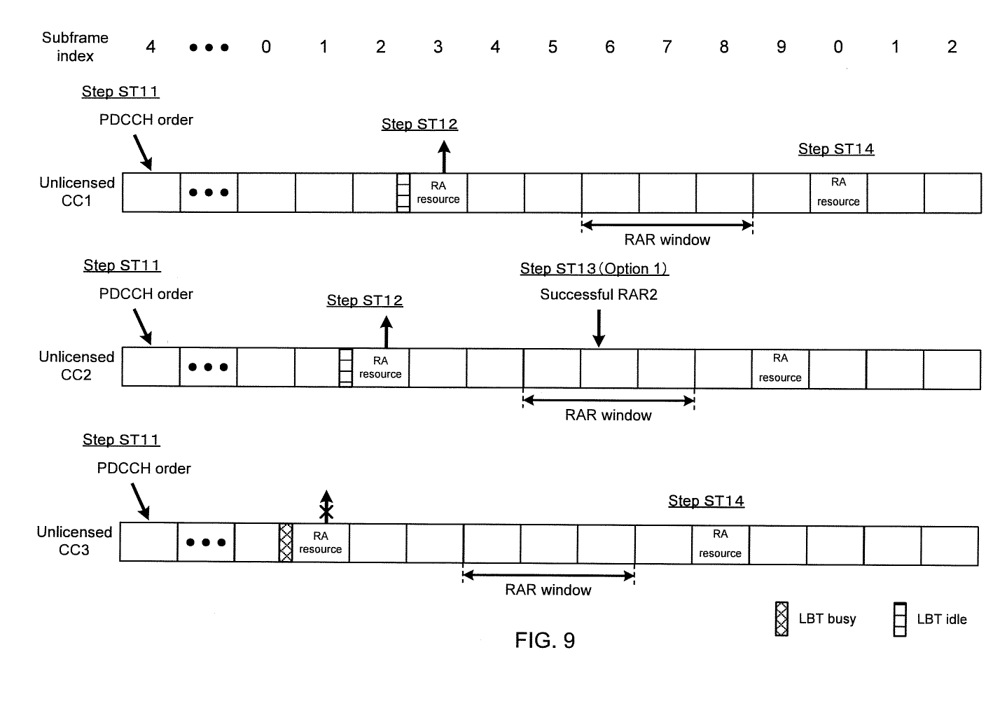

FIG. 9 is a drawing depicting an example of the RA procedure according to a modification example of the first embodiment. In this example, the UE has succeeded in PRACH transmission on the CC1 and the CC2, just as in FIGS. 7 and 8, and the eNBs choose the CC2 and transmit a RAR on the CC2, in accordance with option 1.

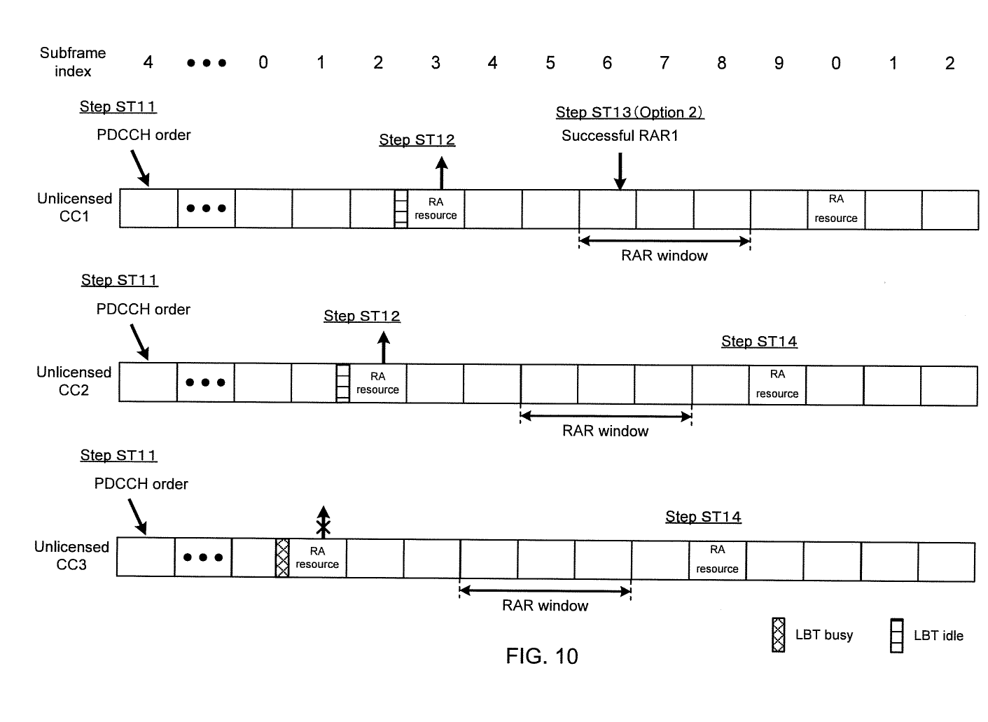

FIG. 10 is a drawing depicting another example of the RA procedure according to the modification example of the first embodiment. In this example, the UE has succeeded in PRACH transmission on the CC1 and the CC2, just as in FIGS. 7 and 8, and the eNBs choose the CC1 having a minimum CC index and transmit a RAR on the CC1, in accordance with option 2.

In FIG. 10, if the UE grasps the specific rule to be used for the choice of a CC when the eNBs receive a plurality of PRACHs, the UE may attempt to receive a RAR only on a CC on which the RAR is assumed to be transmitted. For example, in FIG. 10, when the UE grasps the specific rule that the eNBs transmit a RAR on a CC having a minimum CC index, the UE may not attempt to receive a RAR in a RAR window of CC2.

The UE may be notified of information about the specific rule by higher layer signaling (e.g., RRC signaling, broadcast information (master information block (MIB), system information block (SIB)), and the like), another signal, or a combination thereof.

The modification example of the first embodiment eliminates the need for the eNBs to transmit a plurality of RARs, thus preventing an increase in communication overhead.

### Second Embodiment

In a second embodiment of the present invention, when multiple CCs to which LBT is applied belong to one TAG, a UE receives one PRACH trigger related to at least two or more CCs belonging to the TAG, and starts performing an RA procedure common to the multiple CCs (an RA procedure straddling the multiple CCs). In the RA procedure, when a RAR is successfully received on any of the CCs, the UE stops transmission or retransmission of RA preambles on the other CCs.

In other words, in the second embodiment, the RA procedure is performed while regarding multiple (e.g., all) unlicensed CCs belonging to the same TAG as one CC. The RA procedure common to the CCs may be referred to as an RA procedure shared to the CCs.

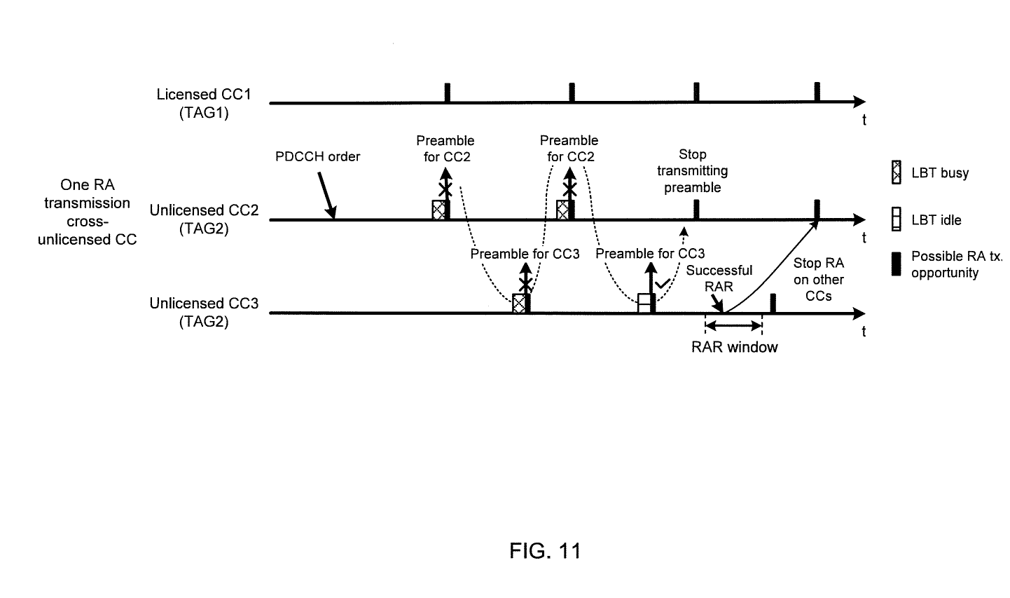

FIG. 11 is a schematic explanatory view of the second embodiment. FIG. 11 depicts the same example as FIG. 5B. In the example of FIG. 11, a UE starts one RA procedure related to CC2 and CC3 in response to one PDCCH order. The UE succeeds in TRACH transmission on the CC3 and in receiving a RAR in a RAR window, and thereafter avoids performing PRACH transmission on the CC2 belonging to the same TAG.

To be more specific, an example of the second embodiment is embodied by the following steps ST21 to ST23. First, an eNB transmits one PDCCH order to any of unlicensed CCs belonging to the same TAG so as to trigger a start of an RA procedure common to the multiple CCs (step ST21). The PDCCH order may include information for indicating transmission of RA over multiple CCs, or information for specifying multiple (two or more) CCs used in an RA procedure (for example, an x (x>1) number of CC indexes). In FIG. 11, the PDCCH order is transmitted to a CC2.

The UE performs LBT on an unlicensed CC having the latest RA resource out of the multiple unlicensed CCs on which the RA procedure is ordered to be performed in step ST21 (step ST22). When LBT results in LBT_{idle}, the UE performs PRACH transmission on the CC on which LBT is performed, while the UE does not perform (stops) PRACH transmission on the other unlicensed CCs belonging to the same TAG until a RAR window corresponding to the performed PRACH transmission elapses. On the other hand, when LBT results in LBT_{busy}, the UE continues performing LBT on another unlicensed CC having the next-latest RA resource.

An eNB receives an RA preamble on each of the triggered CCs, and transmits a RAR in response to the successfully received PRACH on a PCell (step ST23). When the RAR related to the CC on which the PRACH has been transmitted is successfully received, the UE can apply a TA value included in the RAR to a TAG to which the CC belongs. On the other hand, when failing the RAR reception, the UE returns to step ST22, and continues performing LBT on another unlicensed CC having the next-latest RA resource.

The UE controls the transmission power of the PRACH (power ramping) using one common preamble transmission number related to the multiple unlicensed CCs belonging to the same TAG based on the order in step ST21. For example, when LBT on some CC results in LBT_{busy}, the UE controls the common preamble transmission number to be prohibited from incrementing. When there is a CC that has succeeded in PRACH transmission in the TAG, the UE increments the common preamble transmission number by a certain number (e.g., 1) irrespective of which the CC is.

To be more specific, in the second embodiment, the common preamble transmission number (the preamble transmission number shared to the CCs) is incremented by 1, when after transmitting a PRACH on a certain CC, no RAR is received in a RAR window of the certain CC or a received RAR does not include an identifier (RAPID) corresponding to the transmitted RA preamble, and/or when in the certain CC, a PHY layer does not inform a MAC layer of information about a stop of power ramping (when LBT results in LBT_{idle}).

In the second embodiment, the common preamble transmission power may be controlled based on an equation in which

PREAMBLE_TRANSMISSION_COUNTER is regarded as the common preamble transmission power (COMMON_PREAMBLE_TRANSMISSION COUNTER) in equation (2), or another equation.

In the UE, a RAR window size, parameters related to transmission and retransmission power of a preamble, and the like may be set by higher layer signaling on a CC-by-CC basis. At least one of the parameters may be set at a common value to the multiple CCs.

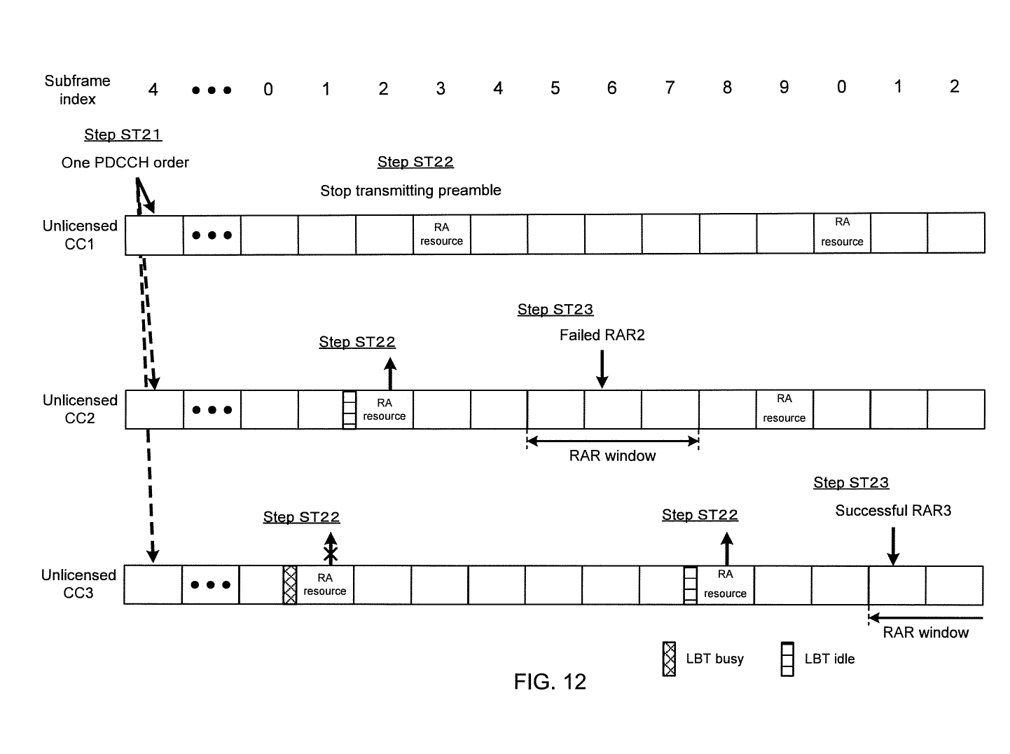

A concrete example of the second embodiment will be described below. FIG. 12 is a drawing depicting an example of an RA procedure according to the second embodiment. In this example, just as with FIG. 7, CA of three unlicensed band CCs (CC1 to CC3) is applied to a UE. In each CC, a RAR window is set at 3.

In FIG. 12, the UE receives a PDCCH order for a TAG to which the CC1 to CC3 belong, on any of the CCs in a certain subframe so as to trigger an RA procedure straddling the CCs (step ST21). In this example, the UE grasps that the PDCCH order makes an RA resource of each CC available with a period of 7 subframes, and continuous subframes are allocated in order of CC3, CC2, and CC1.

Next, the UE performs processing of step ST22. First, the UE performs LBT on the CC3 having the latest RA resource in subframe #0, in order to perform PRACH transmission on the CC3 in subframe #1. In this embodiment, LBT results in LBT_{busy}, the PRACH transmission cannot be performed on the CC3. In this case, as described above, the common preamble transmission number is not incremented.

Since LBT performed on the CC2 in subframe #1 results in LBT_{idle}, the UE performs PRACH transmission on the CC2 in subframe #2. In this case, the UE stops transmitting preambles of the other CCs (CC1 and CC3), until a RAR window of the CC2 corresponding to the PRACH transmission elapses. Thus, since no PRACH transmission is performed on the CC1 in subframe #3, the UE may not perform LBT for the CC1 in subframe #2.

In step ST23, the UE fails to receive a RAR (failed RAR2) on the CC2. When failing to receive the RAR, the UE can perform the above-described power ramping processing. In this example, the UE may increment the common preamble transmission number by 1 and ramp the power of the next PRACH retransmission on any of the CCs by a powerRampingStep.

The UE performs LBT on the CC3 in subframe #7, in order to perform PRACH transmission on the CC3 having the next latest RA resource. As depicted in FIG. 12, the RAR window of some CCs may overlap with a subframe in which LBT for this or another CC is performed.

In this embodiment, since LBT performed on the CC3 in subframe #7 results in LBT_{idle}, the PRACH transmission is performed on the CC3. The PRACH transmission power is determined based on the common preamble transmission number incremented due to the CC2. In this case, the common preamble transmission number is incremented.

The UE succeeds in receiving a RAR (Successful RAR3) on the CC3 in a RAR window (next subframe #1) corresponding to the PRACH. Owing to the success in the RAR reception on the CC3, the UE can obtain a TA.

According to the above-described second embodiment, starting the RA procedure that straddles the multiple unlicensed CCs allows for reducing the effects of a reduction in opportunities of PRACH transmission due to LBT. Since each RA procedure is stopped after the TA has been obtained, it is possible to prevent an increase in a load of the UE.

### Radio Communication System

The configuration of a radio communication system according to an embodiment of the present invention will be described below. A radio communication method according to any of the above embodiments of the present invention and/or a combination thereof is applied to the radio communication system.

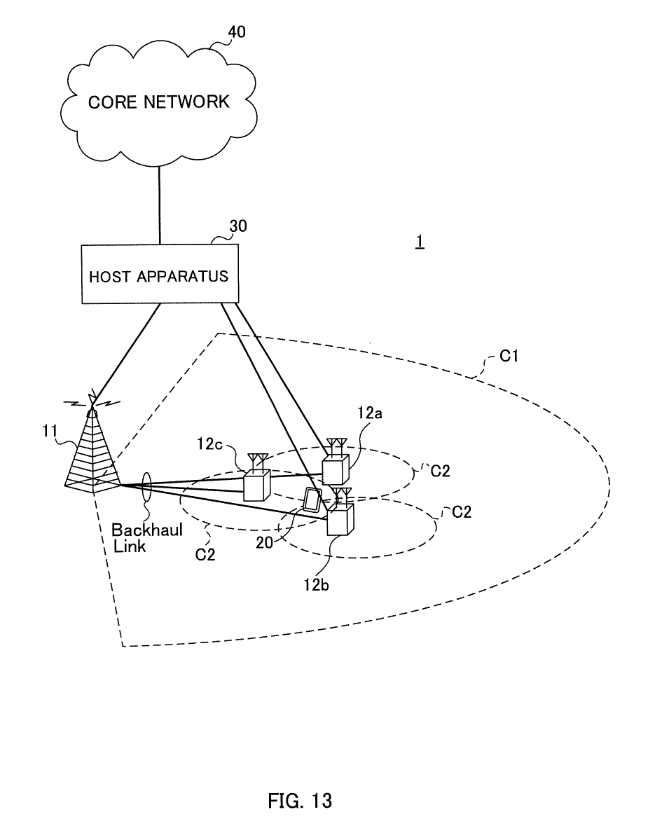

FIG. 13 is a drawing depicting an example of the schematic configuration of the radio communication system according to an embodiment of the present invention. A radio communication system 1 applies Carrier Aggregation (CA) and/or Dual Connectivity (DC) to aggregate multiple basic frequency blocks (component carriers) in units of system bandwidths of LTE systems. The radio communication system 1 has radio base stations (e.g., LTE-U base stations) that can use unlicensed bands.

The radio communication system 1 may be also referred to as SUPER 3G, LTE-Advanced (LTE-A), IMT-Advanced, 4th generation mobile communication system (4G), 5th generation mobile communication system (5G), Future Radio Access (FRA), and the like.

As depicted in FIG. 13, the radio communication system 1 includes a radio base station 11 for forming a macro cell C1, and radio base stations 12 (12a to 12c) that are disposed in the macro cell C1 and form smaller cells C2 than the macro cell C1. A user terminal 20 is disposed in the macro cell C1 and the small cells C2. For example, it is conceivable to use the macro cell C1 as a licensed band, and use the small cells C2 as unlicensed bands (LTE-U). It is also conceivable to use a part of the small cells as a licensed band, and use the other small cell as an unlicensed band.

The user terminal 20 can be connected to both of the radio base station 11 and the radio base stations 12. The user terminal 20 is assumed to concurrently use the macro cell C1 and the small cells C2 using different frequencies by CA or DC. For example, the radio base station 11 using the licensed band can transmit assistance information (e.g., DL signal structure) related to the radio base stations 12 (e.g., LTE-U base stations) using the unlicensed bands to the user terminal 20. When CA is applied to the licensed band and the unlicensed bands, one radio base station (e.g., radio base station 11) may control the schedules of the licensed band cell and the unlicensed band cells.

The user terminal 20 may not be connected to the radio base station 11 but connected to the radio base stations 12. For example, the user terminal 20 may be connected to the radio base stations 12 using the unlicensed bands on a standalone basis. In this case, the radio base station 12 controls schedules of the unlicensed band cells.

The user terminal 20 can communicate with the radio base station 11 using a narrow band carrier (an existing carrier, a legacy carrier, or the like) in a relatively low frequency band (for example, 2 GHz). On the other hand, the user terminal 20 may communicate with the radio base station 12 using a wide band carrier in a relatively high frequency band (for example, 3.5 GHz, 5 GHz, or the like), or using the same carrier as for the radio base station 11. The structure of the frequency band used by each radio base station is not limited thereto.

The radio base station 11 and the radio base station 12 (or the two radio base stations 12) are connected with a wire (e.g., a Common Public Radio Interface (CPRI)-compliant optical fiber, an X2 interface, or the like), or connected wirelessly.

Each of the radio base stations 11 and 12 is connected to a host apparatus 30, and connected to a core network 40 through the host apparatus 30. The host apparatus 30 includes, for example, an access gateway device, a radio network controller (RNC), a mobility management entity (MME), and the like, but is not limited thereto. Each radio base station 12 may be connected to the host apparatus 30 through the radio base station 11.

The radio base station 11 is a radio base station having a relatively large coverage, and may be also referred to as a macro base station, an aggregation node, an eNodeB (eNB), a transmission and reception point, and the like. The radio base station 12 is a radio base station having a local coverage, and may be also referred to as a small base station, a micro base station, a pico base station, a femto base station, a Home eNodeB (HeNB), a remote radio head (RRH), a transmission and reception point, and the like. The radio base stations 11 and 12 are collectively called radio base stations 10, when not distinguishing therebetween. The radio base stations 10 that share a single unlicensed band are preferably in synchronization with each other.

The user terminal 20 is a terminal compliant to various communication schemes such as LTE and LTE-A, and may include a stationary communication terminal, as well as a mobile communication terminal.

In the radio communication system 1, Orthogonal Frequency Division Multiple Access (OFDMA) is applied to a downlink, while Single Carrier Frequency Division Multiple Access (SC-FDMA) is applied to an uplink, as radio access schemes. OFDMA is a multicarrier transmission scheme in which a frequency band is divided into multiple narrow frequency bands (subcarriers) and communication is performed by mapping data to the subcarriers. SC-FDMA is a single carrier transmission scheme in which a system bandwidth is divided on a terminal-by-terminal basis into bands each of which is constituted of one or two or more continuous resource blocks, and terminals use the different bands from each other in order to prevent interference between the terminals. The uplink and downlink radio access schemes are not limited to this combination.

The radio communication system 1 uses a physical downlink shared channel (PDSCH) shared among the user terminals 20, a physical broadcast channel (PBCH), a downlink L1/L2 control channel, and the like, as downlink channels. The PDSCH carries user data, higher layer control information, system information blocks (SIBs), and the like. The PBCH carries a master information block (MIB).

The downlink L1/L2 control channel includes a physical downlink control channel (PDCCH), an enhanced physical downlink control channel (EPDCCH), a physical control format indicator channel (PCFICH), a physical hybrid-ARQ indicator channel (PHICH), and the like. The PDCCH carries downlink control information (DCI) including scheduling information about the PDSCH and a PUSCH, and the like. The PCFICH carries the number of OFDM symbols used in the PDCCH. The PHICH carries HARQ delivery confirmation information (ACK/NACK) in response to the PUSCH. The EPDCCH is frequency division multiplexed with the PDSCH, and carries the DCI just as with the PDCCH.

The radio communication system 1 uses a physical uplink shared channel (PUSCH) shared among the user terminals 20, an uplink L1/L2 control channel (physical uplink control channel (PUCCH)), a physical random access channel (PRACH), and the like, as uplink channels. The PUSCH may be referred to as an uplink data channel. The PUSCH carries user data, higher layer control information, and the like. The PUCCH carries downlink radio quality information (channel quality indicator (Cal)), delivery confirmation information (ACK/NACK), and the like. The PRACH carries random access preambles to establish connection with cells.

In the radio communication system 1, a cell-specific reference signal (CRS), a channel state information-reference signal (CSI-RS), a demodulation reference signal (DMRS), and the like are transmitted as downlink reference signals. In the radio communication system 1, a sounding reference signal (SRS), a demodulation reference signal (DMRS), and the like are transmitted as uplink reference signals. The DMRS may be referred to as a UE-specific reference signal. The reference signals to be transmitted are not limited thereto.

### Radio Base Station

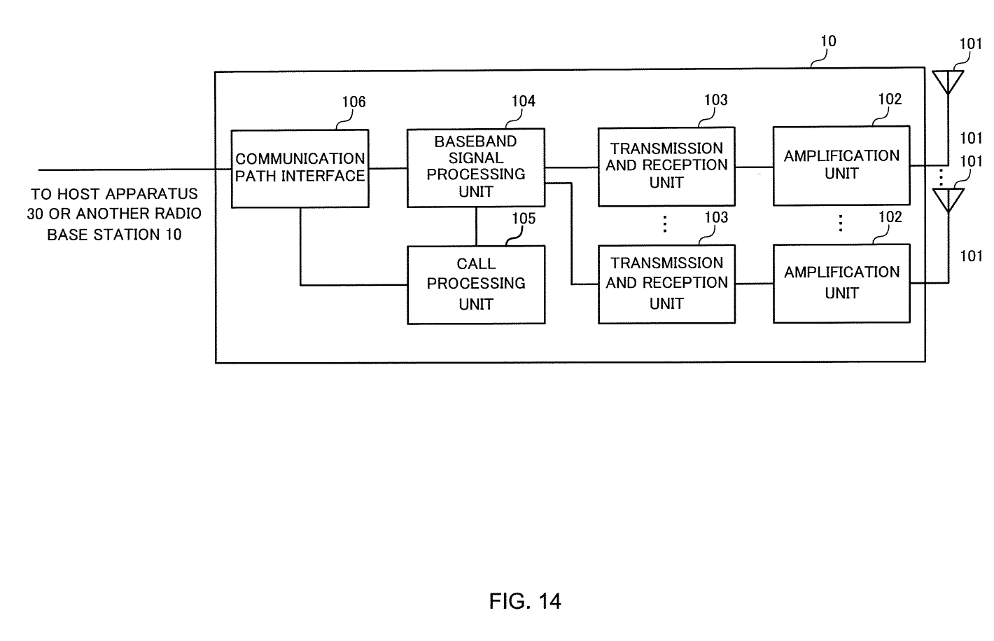

FIG. 14 is a drawing depicting an example of the entire configuration of a radio base station according to the embodiment of the present invention. The radio base station 10 includes transmission and reception antennas 101, amplification units 102, transmission and reception units 103, a baseband signal processing unit 104, a call processing unit 105, and a communication channel interface 106. The number of each of the transmission and reception antennas 101, the amplification units 102, and the transmission and reception units 103 may be one or more.

User data to be transmitted from the radio base station 10 to the user terminal 20 on a downlink is inputted from the host apparatus 30 to the baseband signal processing unit 104 through the communication channel interface 106.

The baseband signal processing unit 104 applies transmission processing, which includes packet data convergence protocol (PDCP) layer processing, the division and coupling of user data, radio link control (RLC) layer transmission processing such as RLC retransmission control, medium access control (MAC) retransmission control (e.g., hybrid automatic repeat request (HARQ) transmission processing), scheduling, a choice of a transmission format, channel encoding, inverse fast Fourier transform (IFFT) processing, precoding, and the like, to the user data, and transfers the processed user data to the transmission and reception units 103. The baseband signal processing unit 104 also applies transmission processing including channel encoding, IFFT processing, and the like to a downlink control signal, and transfers the processed downlink control signal to the transmission and reception units 103.

The transmission and reception unit 103 converts the baseband signal, which is pre-coded and outputted from the baseband signal processing unit 104 on an antenna-by-antenna basis, into a signal in a radio frequency band, and transmits the converted signal. The radio frequency signal that is frequency-converted by the transmission and reception unit 103 is amplified by the amplification unit 102, and transmitted from the transmission and reception antenna 101.

The transmission and reception unit 103 can transmit and receive UL and DL signals on an unlicensed band. The transmission and reception unit 103 may transmit and receive the UL and DL signals on a licensed band. The transmission and reception unit 103 may be constituted of a transmitter and a receiver, a transmission and reception circuit, or a transmission and reception device that is described based on common knowledge in the technical art of the present invention. The transmission and reception unit 103 may be constituted of an integral transceiver unit, or a transmission unit and a reception unit.

As for an uplink signal, a radio frequency signal received by the transmission and reception antenna 101 is amplified by the amplification unit 102. The transmission and reception unit 103 receives the uplink signal amplified by the amplification unit 102. The transmission and reception unit 103 frequency-converts the reception signal into a baseband signal, and outputs the baseband signal to the baseband signal processing unit 104.

The baseband signal processing unit 104 applies fast Fourier transform (FFT) processing, inverse discrete Fourier transform (IDFT) processing, error correction decoding, reception processing for MAC retransmission control, and reception processing of a PLC layer and a PDCP layer to user data included in the inputted uplink signal. The processed uplink signal is transferred to the host apparatus 30 through the communication channel interface 106. The call processing unit 105 performs call processing such as settings and release of communication channels, state management of the radio base station 10, and management of radio resources.

The communication channel interface 106 transmits and receives signals to and from the host apparatus 30 through a certain interface. The communication channel interface 106 may transmit and receive (backhaul signaling) signals to and from another radio base station 10 through an interface (e.g., a common public radio interface (CPRI)-compliant optical fiber or an X2 interface) between the radio base stations.

The transmission and reception unit 103 transmits RA start information and a RAR to the user terminal 20 on a licensed CC and/or an unlicensed CC. The RAR may be transmitted on a PCell or an SCell. For example, the transmission and reception unit 103 may receive a PRACH on a CC, and transmit a RAR corresponding to the PRACH on the CC. The transmission and reception unit 103 receives a PRACH (RA preamble) from the user terminal 20 at least on an unlicensed CC.

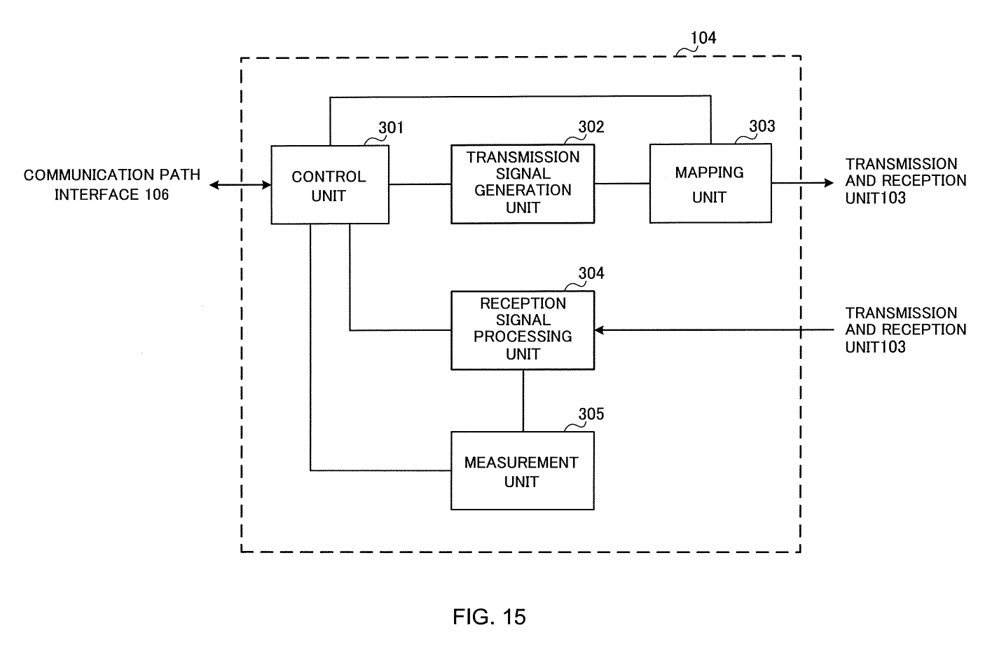

FIG. 15 is a drawing depicting an example of the functional configuration of the radio base station according to the embodiment of the present invention. FIG. 15 mainly depicts functional blocks that are features of the embodiment, and the radio base station 10 has other functional blocks required for radio communication. As depicted in FIG. 15, the baseband signal processing unit 104 includes at least a control unit (scheduler) 301, a transmission signal generation unit 302, a mapping unit 303, a reception signal processing unit 304, and a measurement unit 305. A part or all of the configuration of FIG. 15 may not be included in the baseband signal processing unit 104, as long as the configuration of FIG. 15 is included in the radio base station 10.

The control unit (scheduler) 301 controls the entire radio base station 10. When the single control unit (scheduler) 301 performs scheduling of both of a licensed band and an unlicensed band, the control unit 301 controls communication on the licensed band cell and the unlicensed band cell. The control unit 301 is constituted of a controller, a control circuit, or a control device that is described based on common knowledge in the technical art of the present invention.

The control unit 301 controls, for example, generation of signals by the transmission signal generation unit 302, and allocation of the signals by the mapping unit 303. The control unit 301 also controls signal reception processing by the reception signal processing unit 304, and measurement of signals by the measurement unit 305.

The control unit 301 controls scheduling (e.g., resource allocation) of system information, downlink data signals to be transmitted on the PDSCH, and downlink control signals to be transmitted on the PDCCH and/or EPDCCH. The control unit 301 controls scheduling of synchronization signals (primary synchronization signal (PSS) and secondary synchronization signal (SSS)) and downlink reference signals such as the CRS, the CSI-RS, and the DMRS.

The control unit 301 controls scheduling of uplink data signals to be transmitted on the PUSCH, uplink control signals (e.g., delivery confirmation signal (HARQ-ACK)) to be transmitted on the PUCCH and/or the PUSCH, random access preambles to be transmitted on the PRACH, uplink reference signals, and the like.

The control unit 301 controls the user terminal 20 to apply UL-CA using MTA. The control unit 301 establishes a TAG consisting of two or more carriers (e.g., unlicensed CCs) that perform listening before uplink transmission for the user terminal 20 and notify the user terminal 20 of information about the TAG (information for specifying the CCs belonging to the TAG, and the like).

The control unit 301 controls RA procedures related to the unlicensed CCs. To be more specific, the control unit 301 may generate a plurality of types of RA start information to perform RA procedures each of which is specific to each of the CCs included in the TAG, and transmit the plurality of types of RA start information to the user terminal 20 (first embodiment). In this case, when receiving PRACHs on one or more CCs that have started the RA procedures, the control unit 301 may transmit a RAR corresponding to each of the one or more CCs, or may choose any CC and transmit a RAR corresponding to the chosen CC.

The control unit 301 may generate one type of RA start information to make the CCs included in the TAG perform a common RA procedure, and transmit the single type of RA start information to the user terminal 20 (second embodiment).

The transmission signal generation unit 302 generates downlink signals (downlink control signals, downlink data signals, downlink reference signals, and the like) based on commands from the control unit 301, and outputs the downlink signals to the mapping unit 303. The transmission signal generation unit 302 is constituted of a signal generator, a signal generation circuit, or a signal generation device that is described based on common knowledge in the technical art of the present invention.

For example, the transmission signal generation unit 302 generates DL assignment indicating allocation information of the downlink signals and a UL grant indicating allocation information of uplink signals, based on commands from the control unit 301. Coding processing and modulation processing are applied to the downlink data signals in accordance with a coding ratio, a modulation scheme, and the like determined based on channel state information (CSI) and the like from each user terminal 20.

The mapping unit 303 maps the downlink signals generated by the transmission signal generation unit 302 to certain radio resources based on commands from the control unit 301, and outputs the mapped signals to the transmission and reception units 103. The mapping unit 303 is constituted of a mapper, a mapping circuit, or a mapping device that is described based on common knowledge in the technical art of the present invention.

The reception signal processing unit 304 applies reception processing (for example, demapping, demodulation, decoding, and the like) to reception signals inputted from the transmission and reception units 103. The reception signals are, for example, uplink signals (uplink control signals, uplink data signals, uplink reference signals, and the like) transmitted from the user terminal 20. The reception signal processing unit 304 is constituted of a signal processor, a signal processing circuit, or a signal processing device that is described based on common knowledge in the technical art of the present invention.

The reception signal processing unit 304 outputs the information decoded by the reception processing to the control unit 301. For example, when receiving the PUCCH including HARQ-ACK, the reception signal processing unit 304 outputs the HARQ-ACK to the control unit 301. The reception signal processing unit 304 outputs the reception signals and the signals after the reception processing to the measurement unit 305.

The measurement unit 305 performs measurement on the received signals. The measurement unit 305 is constituted of a measurement instrument, a measurement circuit, or a measurement device that is described based on common knowledge in the technical art of the present invention.

The measurement unit 305 performs LBT on a carrier (e.g., unlicensed band) to which LBT is applied, based on a command from the control unit 301, and outputs an LBT result (e.g., a determination result of whether a channel state is idle or busy) to the control unit 301.

The measurement unit 305 may measure reception power (e.g., reference signal received power (RSRP)), reception signal strength (e.g., received signal strength indicator (RSSI)), reception quality (e.g., reference signal received quality (RSRQ)), a channel state, and the like of the received signal. Measurement results may be outputted to the control unit 301.

### User Terminal

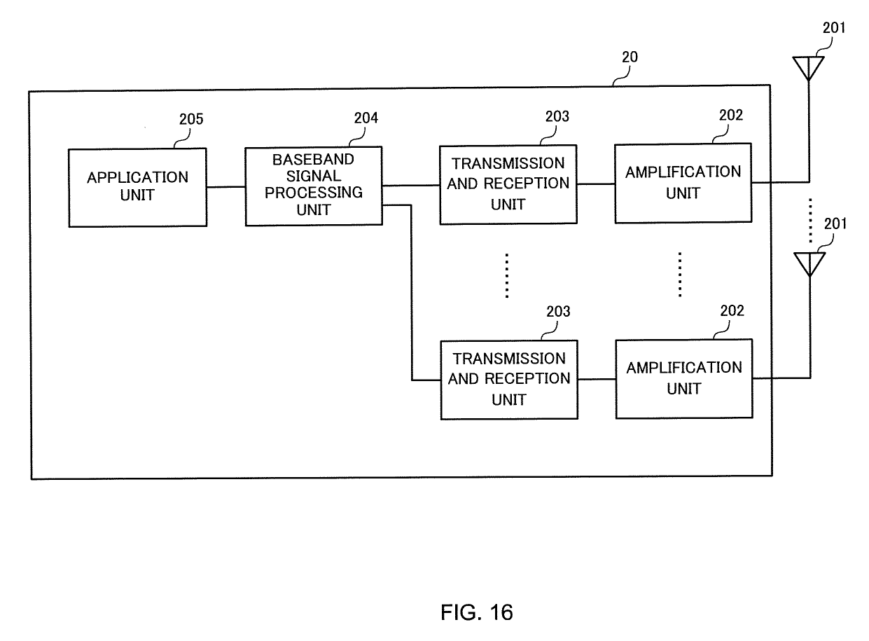

FIG. 16 is a drawing depicting an example of the entire configuration of a user terminal according to the embodiment of the present invention. The user terminal 20 includes transmission and reception antennas 201, amplification units 202, and transmission and reception units 203, a baseband signal processing unit 204, and an application unit 205. The number of each of the transmission and reception antennas 201, the amplification units 202, and the transmission and reception units 203 may be one or more.

Radio frequency signals received by the transmission and reception antennas 201 are amplified by the amplification units 202. Each transmission and reception unit 203 receives the downlink signal amplified by the amplification unit 202. The transmission and reception unit 203 frequency-converts the reception signal into a baseband signal, and outputs the baseband signal to the baseband signal processing unit 204. The transmission and reception unit 203 can transmit and receive UL/DL signals on an unlicensed band. The transmission and reception unit 203 may transmit and receive the UL/DL signals on a licensed band.

The transmission and reception unit 203 is constituted of a transmitter and a receiver, a transmission and reception circuit, or a transmission and reception device that is described based on common knowledge in the technical art of the present invention. The transmission and reception unit 203 may be constituted of an integral transceiver unit, or a transmission unit and a reception unit.

The baseband signal processing unit 204 applies FFT processing, error correction decoding, reception processing for retransmission control, and the like to the inputted baseband signals. The processed downlink user data is transferred to the application unit 205. The application unit 205 performs processing related to higher layers than a physical layer and a MAC layer, and the like. Broadcast information of the downlink data is also transferred to the application unit 205.

Uplink user data is inputted from the application unit 205 to the baseband signal processing unit 204. The baseband signal processing unit 204 applies transmission processing for retransmission control (e.g., HARQ transmission processing), channel coding, precoding, discrete Fourier transform (DFT) processing, IFFT processing, and the like to the user data, and transfers the processed user data to each transmission and reception unit 203. The transmission and reception unit 203 converts the baseband signal outputted from the baseband signal processing unit 204 into a signal in a radio frequency band, and transmits the converted signal. The radio frequency signal that is frequency-converted by the transmission and reception unit 203 is amplified by the amplification unit 202, and transmitted from the transmission and reception antenna 201.

The transmission and reception unit 203 receives RA start information and a RAR from the radio base station 10 on a licensed CC and/or an unlicensed CC. The RAR may be transmitted on a PCell or an SCell. For example, the transmission and reception unit 203 may transmit a PRACH on a CC, and receive a RAR corresponding to the PRACH on the CC. The transmission and reception unit 203 transmits a PRACH to the radio base station 10 at least on an unlicensed CC.

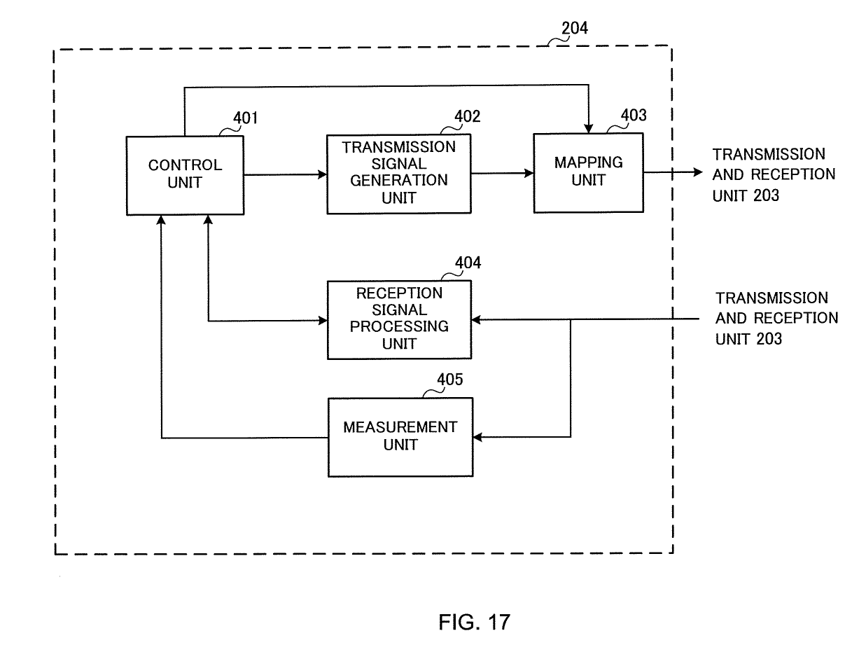

FIG. 17 is a drawing depicting an example of the functional configuration of the user terminal according to the embodiment of the present invention. FIG. 17 mainly depicts functional blocks that are features of the embodiment, and the user terminal 20 has other functional blocks required for radio communication. As depicted in FIG. 17, the baseband signal processing unit 204 includes at least a control unit 401, a transmission signal generation unit 402, a mapping unit 403, a reception signal processing unit 404, and a measurement unit 405. A part or all of the configuration of FIG. 17 may not be included in the baseband signal processing unit 204, as long as the configuration of FIG. 17 is included in the user terminal 20.

The control unit 401 controls the entire user terminal 20. The control unit 401 is constituted of a controller, a control circuit, or a control device that is described based on common knowledge in the technical art of the present invention.

The control unit 401 controls, for example, generation of signals by the transmission signal generation unit 402, and allocation of the signals by the mapping unit 403. The control unit 401 also controls signal reception processing by the reception signal processing unit 404, and measurement of signals by the measurement unit 405.

The control unit 401 receives downlink control signals (signals transmitted on the PDCCH/EPDCCH) and downlink data signals (signals transmitted on the PDSCH) transmitted from the radio base stations 10 through the reception signal processing unit 404. The control unit 401 controls generation of uplink control signals (e.g., a delivery confirmation signal (HARQ-ACK) and the like) and uplink data signals based on the downlink control signals, determination results of necessity for retransmission control for the downlink data signals, and the like.

The control unit 401 may control the transmission signal generation unit 402 and the mapping unit 403 to transmit an uplink signal (e.g., PRACH) on an unlicensed CC in accordance with a LBT result obtained by the measurement unit 405.

The control unit 401 controls an RA procedure related to two or more carriers (e.g., unlicensed CCs) that perform listening before uplink transmission. The control unit 401 applies the same TA to the two or more carriers belonging to a specific group (e.g., TAG).

To be more specific, when a plurality of RA start information are inputted from the reception signal processing unit 404, the control unit 401 may perform RA procedures each of which is specific to each of CCs included in a TAG, based on each RA start information (first embodiment). In this case, upon receiving a plurality of RARs from the reception signal processing unit 404, the control unit 401 determines one CC based on a specific rule, and calculates a TA of the TAG that consists of unlicensed CCs based on a RAR corresponding to the determined CC.

When one RA start information is inputted from the reception signal processing unit 404, the control unit 401 may perform an RA procedure common to CCs included in a TAG based on the one RA start information (second embodiment). In this case, the control unit 401 calculates a TA of the TAG that consists of unlicensed CCs based on a RAR obtained from the reception signal processing unit 404. When a PRACH transmission has succeeded on a CC, the control unit 401 may not perform another PRACH transmission on a TAG to which the CC belongs, until a RAR window elapses.

When the control unit 401 has received at least one RAR related to a CC from the reception signal processing unit 404, the control unit 401 stops RA procedures (cancels transmission of RA preambles) on the other CCs included in a TAG to which the CC belongs.

The control unit 401 may control transmission and retransmission power of a PRACH. The power may be determined based on a preamble transmission number specific to each CC or a (total) preamble transmission number common to CCs.

The transmission signal generation unit 402 generates uplink signals (uplink control signals, uplink data signals, uplink reference signals, and the like) based on commands from the control unit 401, and outputs the generated signals to the mapping unit 403. The transmission signal generation unit 402 is constituted of a signal generator, a signal generation circuit, or a signal generation device that is described based on common knowledge in the technical art of the present invention.

For example, the transmission signal generation unit 402 generates uplink control signals related to delivery confirmation signals (HARQ-ACK) and channel state information (CSI) based on commands from the control unit 401. The transmission signal generation unit 402 also generates uplink data signals based on commands from the control unit 401. For example, when a downlink control signal transmitted from the radio base station 10 includes a UL grant, the control unit 401 commands the transmission signal generation unit 402 to generate an uplink data signal.

The mapping unit 403 maps the uplink signals generated by the transmission signal generation unit 402 to radio resources based on commands from the control unit 401, and outputs the mapped signals to the transmission and reception unit 203. The mapping unit 403 is constituted of a mapper, a mapping circuit, or a mapping device that is described based on common knowledge in the technical art of the present invention.

The reception signal processing unit 404 applies reception processing (for example, demapping, demodulation, decoding, and the like) to reception signals inputted from the transmission and reception units 203. The reception signals are, for example, downlink signals (downlink control signals, downlink data signals, downlink reference signals, and the like) transmitted from the radio base stations 10. The reception signal processing unit 404 is constituted of a signal processor, a signal processing circuit, or a signal processing device that is described based on common knowledge in the technical art of the present invention. The reception signal processing unit 404 constitutes a reception unit according to the present invention.

The reception signal processing unit 404 outputs the information decoded by the reception processing to the control unit 401. The reception signal processing unit 404 outputs, for example, broadcast information, system information, RRC signaling, DCI, and the like to the control unit 401. The reception signal processing unit 404 outputs the reception signals and the signals after the reception processing to the measurement unit 405.

The measurement unit 405 performs measurement on the received signals. The measurement unit 405 is constituted of a measurement instrument, a measurement circuit, or a measurement device that is described based on common knowledge in the technical art of the present invention.

The measurement unit 405 may perform LBT on a carrier (carrier on which listening is performed before transmitting a signal; e.g., unlicensed band) to which LBT is applied, based on a command from the control unit 401. The measurement unit 405 may output a LBT result (e.g., a determination result of whether a channel state is idle or busy) to the control unit 401.

The measurement unit 405 may measure reception power (e.g., RSRP), reception signal strength (e.g., RSSI), reception quality (e.g., RSRQ), a channel state, and the like of the received signal. For example, the measurement unit 405 measures LAA DRS. Measurement results may be outputted to the control unit 401.

### Hardware Configuration

The block diagrams used in the above embodiment depict functional blocks. The functional blocks (elements) are realized by an arbitrary combination of hardware and software. A method for realizing each functional block is not specifically limited. In other words, each functional block may be realized by one physically integrated device, or two or more physically separated devices connected with or without wires.

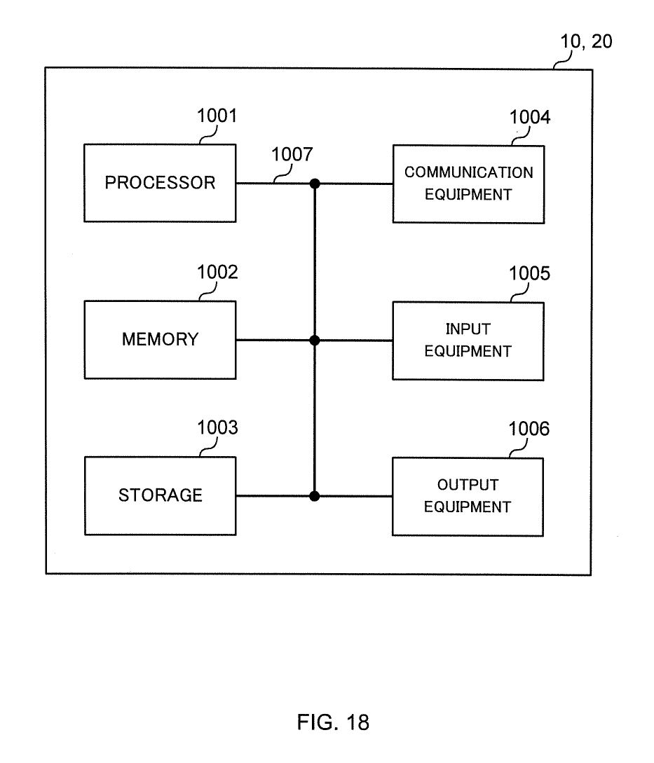

For example, the radio base stations, the user terminal, and the like according to the embodiment of the present invention may be realized by computers that perform processing for the radio communication method according to the present invention. FIG. 18 is an example of the hardware configuration of each of the radio base stations and the user terminal according to the embodiment of the present invention. Each of the above-described radio base stations 10 and the user terminal 20 may be physically constituted of a computer device that includes a processor 1001, a memory 1002, storage 1003, communication equipment 1004, input equipment 1005, output equipment 1006, a bus 1007, and the like.

In the following description, the term “equipment” may be substituted for “circuit”, “device”, “unit”, or the like. The hardware configuration of each of the radio base stations 11 and the user terminal 20 may include one or a plurality of pieces of the equipment depicted in the drawing, or may not include a part of the equipment.

In order to achieve each function of the radio base stations 10 and the user terminal 20, the processor 1001 performs operation so as to control communication by the communication equipment 1004 and reading and/or writing of data by the memory 1002 and the storage 1003, by reading specific software (programs) into hardware such as the processor 1001 and the memory 1002.

The processor 1001 controls the entire computer by executing, for example, an operating system. The processor 1001 may be constituted of a central processing unit (CPU) including an interface with peripheral equipment, a control unit, an arithmetic unit, a resistor, and the like. For example, the above baseband signal processing unit 104 (204), the call processing unit 105, and the like may be realized by the processor 1001.

The processor 1001 loads programs (program code), software modules, and data from the storage 1003 and/or the communication equipment 1004 into the memory 1002, and executes various types of processing in accordance therewith. As the programs, programs that make the computer execute at least a part of the operations described in the above embodiments. For example, the control unit 401 of the user terminal 20 may be stored in the memory 1002, and realized by a control program executed by the processor 1001. The same goes for the other functional blocks.

The memory 1002 is a computer-readable recording medium, and may be constituted of, for example, at least one of a read only memory (ROM), an erasable programmable ROM (EPROM), a random access memory (RAM), and the like. The memory 1002 may be referred to as a resistor, a cache, a main memory (main storage), and the like. The memory 1002 can store a program (program code), a software module, or the like that is executed to perform the radio communication method according to the embodiments of the present invention.

The storage 1003 is a computer-readable recording medium, and may be constituted of, for example, at least one of an optical disk such as a CD-ROM (compact disc ROM), a hard disk drive, a flexible disk, a magneto-optical disk, a flash memory, and the like. The storage 1003 may be referred to as auxiliary storage.

The communication equipment 1004 is hardware (a transmission and reception device) to establish communication between computers through a wired and/or wireless network. The communication equipment 1004 is also referred to as, for example, a network device, a network controller, a network card, a communication module, and the like. For example, the above transmission and reception antenna 101 (201), amplification unit 102 (202), transmission and reception unit 103 (203), communication channel interface 106, and the like may be realized by the communication equipment 1004.

The input equipment 1005 is an input device (e.g., keyboard, mouse, and the like) that receives input from the outside. The output equipment 1006 is an output device (e.g., display, speaker, and the like) that performs external output. The input equipment 1005 and the output equipment 1006 may be integrated (into e.g., a touch panel).

Each piece of the equipment such as the processor 1001 and the memory 1002 is connected through the bus 1007 to communicate information. The bus 1007 may be constituted of a single bus, or buses different from one piece of equipment to another.

Each of the radio base stations 10 and the user terminal 20 may include hardware such as a microprocessor, a digital signal processor (DSP), an application specific integrated circuit (ASIC), a programmable logic device (PLD), and a field programmable gate array (FPGA). The hardware may realize a part or all of each functional block. For example, the processor 1001 may be constituted of at least one piece of the hardware.

The terms described in this application and/or the terms required for understanding this application may be substituted with other terms that refer to the same or similar meanings. For example, the term “channel” and/or “symbol” may be substituted with the term “signal (signaling)”. The term “signal” may be substituted with the term “message”. The term “component carrier (CC)” may be substituted with the term “cell”, “frequency carrier”, “carrier frequency”, or the like.

A radio frame may include one or a plurality of periods (frames) in a time domain. The one or each of the plurality of periods (frames) included in the radio frame may be referred to as a subframe. The subframe may include one or a plurality of slots in the time domain. Each slot may include one or a plurality of symbols (OFDM symbols, SC-FDMA symbols, or the like) in the time domain.

The radio frame, the subframe, the slot, and the symbol represent time units in transmitting signals. Each of the radio frame, the subframe, the slot, and the symbol may be referred to as another designation. For example, one subframe may be referred to as a transmission time interval (TTI), a plurality of continuous subframes may be referred to as a TTI, or one slot may be referred to as a TTI. In other words, the TTI may denote a subframe (1 ms) in existing LTE, a period shorter (e.g., 1 to 13 symbols) than 1 ms, or a period longer than 1 ms.

The TTI denotes, for example, a minimum time unit for scheduling in radio communication. For example, in scheduling by LTE systems, the radio base station allocates radio resources (frequency bandwidths, transmission power, and the like usable in each user terminal) to each user terminal in units of TTI. The definitions of the TTI are not limited thereto.

A TTI having a time length of 1 ms may be referred to as a common TTI (TTI in LTE Releases 8 to 12), a normal TTI, a long TTI, a common subframe, a normal subframe, a long subframe, or the like. A shorter TTI than the common TTI may be referred to as a shortened TTI, a short TTI, a shortened subframe, a short subframe, or the like.

A resource block (RB) is a resource allocation unit in a time domain and a frequency domain, and may include one or a plurality of continuous subcarriers. The RB may include one or a plurality of symbols in the time domain, and have a length of one slot, one subframe, or one TTI. One TTI or one subframe may be constituted of one or a plurality of RBs. The RB may be referred to as a physical RB (PRB), a PRB pair, an RB pair, or the like.

The RB may include one or a plurality of resource elements (REs). For example, one RB may be a radio resource domain of one subcarrier or one symbol.

The above-described structures of the radio frame, subframe, slot, symbol, and the like are just examples. For example, structures such as the number of subframes included in a radio frame, the number of slots included in a subframe, the number of symbols and RBs included in a slot, the number of subcarriers included in an RB, the number of symbols included in a TTI, a symbol length, and a cyclic prefix (CP) length are variously changeable.

The information, parameters, and the like described in this application may be represented in absolute values, relative values with respect to a certain value, or other information corresponding thereto. For example, the radio resources may be indicated by a certain index.

The information, signals, and the like described in this application may be represented by using any of various different techniques. For example, the data, instructions, commands, information, signals, bits, symbols, chips, and the like that are mentioned in the whole of the above description may be represented by voltages, currents, electromagnetic waves, magnetic fields or magnetic particles, optical fields or photons, or arbitrary combinations thereof.

The software, commands, information, and the like may be transmitted and received through a transmission medium. For example, when software is transmitted from a website, a server, or another remote source using wired technology (a coaxial cable, an optical fiber cable, a twist pair and a digital subcarrier line (DSL), and the like) and/or wireless technology (infrared rays, microwaves, and the like), the wired technology and/or the wireless technology are/is included in the definition of the transmission medium.

The radio base stations described in this application may be substituted with user terminals. For example, each aspect and embodiment of the present invention may be applied to a configuration in which communication established between the radio base station and the user terminal is substituted with communication between a plurality of user terminals (Device-to-Device: D2D). In this case, the user terminal 20 may have the functions the above-described radio base station 10. The terms “uplink” and “downlink” may be substituted with “side”. For example, an uplink channel may be substituted with a side channel.

In the same manner, the user terminal in this application may be substituted with a radio base station. In this case, the radio base station 10 may have the functions of the above-described user terminal 20.

Each aspect or embodiment described in this application may be used alone, in combination, or by switching in accordance with execution. Notification about certain information (for example, notification about being X) is not limited to be explicit, and may be implicit (for example, without the notification about the information).

Notification about information is not limited to the aspect or embodiment described in this application, but may be performed in another way. For example, the notification about information may be performed by physical layer signaling (e.g., downlink control information (DCI) and uplink control information (UCI)), higher layer signaling (e.g., radio resource control (RRC) signaling, broadcast information (master information block (MIB), system information blocks (SIBs), and the like), medium access control (MAC) signaling, another signal, or a combination thereof. The RRC signaling may be referred to as an RRC message, and may be, for example, an RRC Connection Setup message, an RRC Connection Reconfiguration message, or the like. The MAC signaling may be notified by, for example, a MAC control element (CE).

Each aspect or embodiment described in this application may be applied to systems using Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-Radio Access Technology (RAT), Global System for Mobile communications (GSM (trademark)), CDMA2000, Ultra Mobile Broadband (UMB), IEEE 802.11 (Wi-Fi (trademark)), IEEE 802.16 (WiMAX (trademark)), IEEE 802.20, Ultra-WideBand (UWB), Bluetooth (trademark), and other appropriate systems, and/or next generation systems extended based thereon.

The processing procedure, sequence, flowchart, and the like of each aspect or embodiment described in this application may be permuted as long as there is no contradiction. For example, as to the method described in this application, the elements of various steps are proposed in an exemplary order, and are not limited to the specific proposed order.

The present invention is described above in detail, but as a matter of course, it is apparent for those skilled in the art that the present invention is not limited to the embodiments described in this application. For example, each of the above embodiments may be used alone or in combination. The present invention can be modified and changed in other forms without departing from the intent and scope of the present invention defined by claims. Therefore, this application is intended to exemplarily describe the present invention, and has no limitation to the present invention.

The disclosure of Japanese Patent Application No. 2016-020014, filed on Feb. 4, 2016, including the specification, drawings and abstract, is incorporated herein by reference in its entirety.

1. A user terminal comprising:
a control unit for controlling a random access procedure on two or more carriers on which listening is performed before uplink transmission;
a transmission unit for transmitting a random access preamble on at least one of the two or more carriers; and
a reception unit for receiving a response signal in response to the random access preamble, wherein
the control unit controls the transmission unit to stop transmission of the random access preamble on the two or more carriers in accordance with reception of the response signal.

2. The user terminal according to claim 1, wherein the control unit controls to use a same uplink transmission timing information for a specific group including the two or more carriers, based on the response signal.

3. The user terminal according to claim 1, wherein
the reception unit receives a plurality of random access start information, and
the control unit controls to perform a plurality of the random access procedures on the two or more carriers on an individual basis based on each random access start information.

4. The user terminal according to claim 3, wherein when the reception unit receives a plurality of the response signals, the control unit controls to obtain uplink transmission timing information based on the response signal that has been received on a specific carrier determined based on a specific rule.

5. The user terminal according to claim 1, wherein
the reception unit receives one random access start information, and
the control unit controls to perform the random access procedure common to the two or more carriers based on the one random access start information.

6. The user terminal according to claim 5, wherein the one random access start information includes information for specifying the two or more carriers to be used in the common random access procedure.

7. The user terminal according to claim 5, wherein the control unit controls transmission power of the random access preamble by using one common preamble transmission number in the common random access procedure.

8. The user terminal according to claim 5, wherein after the random access preamble is transmitted on a certain carrier in the common random access procedure, the control unit stops transmission of the random access preamble on the others of the two or more carriers, until a reception attempt period of the response signal in response to the random access preamble elapses.

9. A radio base station comprising:
a transmission unit for transmitting one or more random access start information related to two or more carriers on which listening is performed before uplink transmission;
a reception unit for receiving a random access preamble transmitted from a user terminal based on the one or more random access start information; and
a control unit for controlling transmission of a response signal in response to the random access preamble, wherein
transmission of the random access preamble on the two or more carriers is stopped on the user terminal in accordance with reception of the response signal.

10. A radio communication method comprising:
a control step for controlling a random access procedure on two or more carriers on which listening is performed before uplink transmission;
a transmission step for transmitting a random access preamble on at least one of the two or more carriers; and
a reception step for receiving a response signal in response to the random access preamble, wherein
the control step controls transmission of the random access preamble on the two or more carriers to be stopped in accordance with reception of the response signal.
